(19) United States
(12) Patent Application Publication
(10) Pub. No.: US 2026/0136048 A1
(43) Pub. Date: May 14, 2026

(54) MULTI-CONTENT DELIVERY NETWORK (CDN) AND 5G MEDIA STREAMING OF MEDIA DATA

(71) Applicant: QUALCOMM Incorporated, San Diego, CA (US)

(72) Inventors: Thomas Stockhammer, Bergen (DE); Imed Bouazizi, Celina, TX (US)

(21) Appl. No.: 19/373,221

(22) Filed: Oct. 29, 2025

Related U.S. Application Data
(60) Provisional application No. 63/718,285, filed on Nov. 8, 2024.

(51) Int. Cl. H04N 21/2365; H04N 21/61; H04N 21/84

(52) U.S. Cl. CPC H04N 21/2365; H04N 21/6131; H04N 21/84

(57) ABSTRACT

An example device for retrieving media data includes: a memory configured to store media data; and a processing system implemented in circuitry and configured to: determine that media data of a media presentation is available from multiple service locations; send a request for the media data of the media presentation such that the request specifies that the media data is to be retrieved using the multiple service locations; and retrieve the media data from at least one of the multiple service locations. For example, to retrieve the media data, the processing system may be configured to: retrieve a first portion of the media data from a first service location via a first transport session, and retrieve a second portion of the media data from a second, different service location via a second transport session.

This application claims the benefit of U.S. Provisional Application No. 63/718,285, filed Nov. 8, 2024, the entire contents of which are hereby incorporated by reference.

### TECHNICAL FIELD

This disclosure relates to storage and transport of encoded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for streaming media data using multiple service locations, e.g., multiple content delivery networks (CDNs), over a radio access network (RAN), e.g., a 5G network. Per the techniques of this disclosure, a client device may retrieve media data from a variety of different service locations/CDNs. These techniques may improve performance of media streaming due to the capability of using bandwidth available between the client device and multiple CDNs or service locations, rather than being limited to a single CDN or single service location. Moreover, the CDNs or service locations may be used in the alternative to each other, such that the client device may retrieve media data from a most appropriate CDN or service location based on factors such as, for example, available bandwidth, location, cost, or the like. Furthermore, this disclosure describes techniques by which common multisource media format (CMMF) streaming sessions may be used in combination with multiple CDNs or service locations.

In one example, a method of retrieving media data includes: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations. The method may further include establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

In another example, a device for retrieving media data includes: a memory configured to store media data; and a processing system implemented in circuitry and configured to: determine that media data of a media presentation is available from multiple service locations; generate a request for the media data of the media presentation such that the request specifies that the media data is to be retrieved using the multiple service locations; and retrieve the media data from at least one of the multiple service locations. To retrieve the media data, the processing system may be configured to: establish a first transport session with a first service location of the multiple service locations; establish a second transport session with a second service location of the multiple service locations, the second service location being different than the first service location; retrieve a first portion of the media data from the first service location via the first transport session; and retrieve a second portion of the media data from the second service location via the second transport session.

In another example, a method of exchanging media data includes: receiving, by a server device, a request for a media player entry for a media presentation from a client device; determining, by the server device, that media data of the media presentation is available from multiple service locations; and sending, by the server device, the media player entry for the media presentation to the client device, the media player entry indicating that the media data of the media presentation is available from the multiple service locations.

In another example, a server device for exchanging media data includes: a memory configured to store a media player entry for a media presentation; and a processing system implemented in circuitry and configured to: receive a request for the media player entry from a client device; determine that media data of the media presentation is available from multiple service locations; and send the media player entry for the media presentation to the client device, the media player entry indicating that the media data of the media presentation is available from the multiple service locations.

In another example, a method of retrieving media data includes determining, by a client device, that media data of a media presentation is available from multiple service locations; sending, by the client device, a request for the media data of the media presentation, including specifying in the request that the media data is to be retrieved using the multiple service locations; and sending, by the client device, the request to retrieve the media data from at least one of the multiple service locations.

In another example, a device for retrieving media data includes a memory configured to store media data; and a processing system implemented in circuitry and configured to: determine that media data of a media presentation is available from multiple service locations; send a request for the media data of the media presentation, wherein the request specifies that the media data is to be retrieved using the multiple service locations; and retrieve the media data from at least one of the multiple service locations.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an example set of components of the retrieval unit of FIG. 1 in greater detail.

FIG. 3 is a conceptual diagram illustrating elements of example multimedia content.

FIG. 4 is a block diagram illustrating elements of an example video file.

FIG. 5 is a block diagram illustrating an example 5G Media Streaming architecture.

FIG. 6 is a block diagram illustrating an example multi-CDN architecture in which the multi-CDN is a feature of a 5GMS application server (AS) and/or of a 5GMS application provider (AP).

FIG. 7 is a block diagram illustrating an example implementation of multi-CDNs using a 5GMSd with multiple CDNs.

FIG. 8 is a block diagram illustrating another example implementation of multi-CDNs using a 5GMSd with multiple CDNs.

FIG. 9 is a block diagram illustrating an example implementation of multi-CDNs using multiple 5GMSd ASes, each acting as a different CDN or service location.

FIG. 10 is a block diagram illustrating another example implementation of multi-CDNs using multiple 5GMSd ASes, each acting as a different CDN or service location.

FIG. 11 is a block diagram illustrating an example architecture for a 5GMSd AS to act as a multiple service location host.

FIG. 12 is a call flow diagram in which a 5GMSd AS, such as that of FIG. 11, acts as a multiple service location host.

FIG. 13 is a call flow diagram illustrating an example method for performing multiple service location streaming using a 5GMSd AS as a multiple service location host.

FIG. 14 is a block diagram illustrating an example content steering architecture.

FIG. 15 is a call flow diagram illustrating an example method for retrieving media data from multiple CDNs using a content steering server, e.g., per the architecture of FIG. 14.

FIG. 16 is a call flow diagram illustrating an example method including updates to incorporate a 5GMSd AS into the architecture of FIG. 14.

FIG. 17 is a call flow diagram illustrating a method of using a content steering server for multiple service locations according to techniques of this disclosure.

FIG. 18 is a block diagram illustrating an example CMMF architecture.

FIG. 19 is a call flow diagram illustrating an example FLUTE-based CMMF CDP instantiation.

FIG. 20 is a conceptual diagram illustrating an example set of CMMF transport objects and transport sessions.

FIGS. 21-23 are conceptual diagram illustrating example encoding options for CMMF transport objects.

FIG. 24 is a block diagram illustrating a combined CDP-based CMMF and 5G media streaming architecture.

FIG. 25 is a call flow diagram illustrating a provisioning call flow using CMMF.

FIG. 26 is a call flow diagram illustrating a method for performing media streaming using CMMF and multiple service locations according to techniques of this disclosure.

FIG. 27 is a flowchart illustrating an example method of retrieving media data available from multiple service locations per techniques of this disclosure.

FIG. 28 is a flowchart illustrating an example method of exchanging media data by a server device per techniques of this disclosure.

### DETAILED DESCRIPTION

In general, this disclosure describes techniques for streaming media data from multiple service locations, such as multiple content delivery networks (CDNs). Multi-CDN generally provides content in a redundant manner on locations that can be differentiated by a client device (e.g., a user equipment (UE) device). The locations may be differentiated by one or multiple Quality-of-Service criteria, for example, the access bandwidth may be different, the reliability of the end points may be different, the costs for the service provider may be different, outage probabilities may be different, and so on. While referred to as multi-CDN, the concept may generally be referred to as “multiple service locations.” Multi-CDNs are merely one example of such techniques. In general, references to multi-CDN may be understood as also applying to multiple service locations.

Content may be offered fully redundant on multiple CDNs, or content may be offered as subsets on one or the other CDN or coded redundant versions may be generated. Decisions on which location to use at which time may be performed by the client device, by instructions from the network or service provider, or by a combination of the two. Multi-CDN approaches may also be considered in broadcast, multicast, and/or unicast scenarios, or combinations thereof. For example, a central CDN may host common video data, but audio data and/or timed text (e.g., closed caption) data may be hosted by different CDNs for different languages, and may be positioned such that languages frequently used in a geographic location are hosted by a CDN having audio and timed text in or near that geographic location.

A service location defines a collection of network resources that share commonalities and can be referred to by a common label. Several elements in a manifest file, such as a media presentation description (MPD), of type xs: anyURI may have an associated @serviceLocation attribute, which provides the label for a Service Location. If two resources share the same value for this attribute, (i.e., they are assigned to the same Service Location), then these URLs are likely to have their URLs resolve to services at a common network location, for example a common Content Delivery Network.

If the element does not include a @serviceLocation attribute, no relationship to any resource in the MPD is known. The string value of @serviceLocation may contain characters selected from the set [a . . . z], [A . . . Z], [0 . . . 9], ‘.’, ‘-’, and ‘_’. A client device may, for example, use such information in order to correlate network statistics from the collected statistics when resolving to a URL at the same service location to predict behavior when resolving for another resource at the same service location. Service locations may, for example, be used to annotate redundant content offerings. In this case, for example, a content steering operation may use values of service locations to steer the client towards a specific version of the redundant content offering.

The techniques of this disclosure may be applied to video files conforming to video data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats.

In HTTP streaming, such as Dynamic Adaptive Streaming over HTTP (DASH), frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more Periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

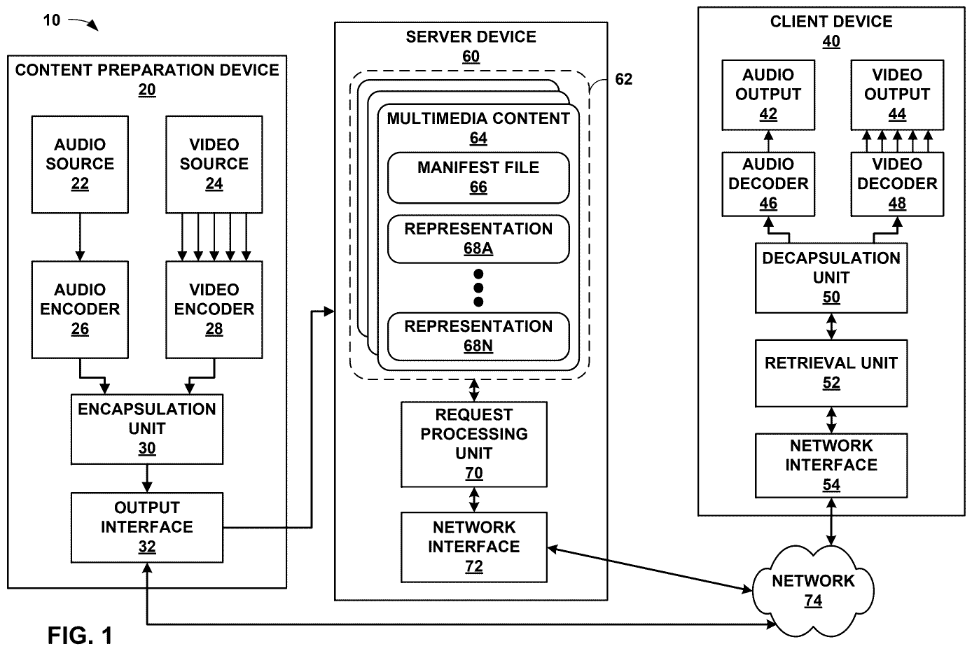

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the upcoming High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol-HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as evolved Multimedia Broadcast Multicast Service (eMBMS). Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Per techniques of this disclosure, client device 40 may be configured to determine that media data of a media presentation is available from multiple service locations. Client device 40 may make this determination through retrieval of a media player entry, such as a manifest file, e.g., a Media Presentation Description (MPD), which contains data explicitly representing the multiple available locations. The media player entry may include an @serviceLocation attribute that can be used to label resources, indicating that such resources may resolve to a common network location, such as a specific content delivery network (CDN). After a media player application (e.g., retrieval unit 52) of client device 40 retrieves this media player entry, the media player application may send a notification to a Media Session Handler (MSH) on the device to confirm the retrieval. In a 5G streaming context, client device 40 may also retrieve specific service location information (such as a BaseURL for media data of a media presentation) directly from a 5G Media Streaming for Downlink (5GMSd) application server (AS).

Client device 40 may also generate a request for the media data of the media presentation, where the request specifies that the media data is to be retrieved using multiple service locations. This request can be tailored to different retrieval strategies. For instance, the request can be generated to include specific content steering parameters, which are used to interact with a content steering server that instructs the client on which CDN or service location to use at a given time. Alternatively, if the system uses the Common Multisource Media Format (CMMF), client device 40 may first establish a transport session to receive CMMF configuration information before generating the request for the actual media data.

Client device 40 may further retrieve the media data from at least one of the multiple service locations. In one example, client device 40 may establish a first transport session with one service location and a second transport session with a second, different service location, then retrieve a first portion of the media data from the first service location via the first transport session, and retrieve a second portion of the media data from the second service location via the second transport session.

In this manner, client device 40 represents an example of a device for retrieving media data, including: a memory configured to store media data; and a processing system implemented in circuitry and configured to: determine that media data of a media presentation is available from multiple service locations; generate a request for the media data of the media presentation such that the request specifies that the media data is to be retrieved using the multiple service locations; and retrieve the media data from at least one of the multiple service locations. To retrieve the media data, the processing system may be configured to: establish a first transport session with a first service location of the multiple service locations; establish a second transport session with a second service location of the multiple service locations, the second service location being different than the first service location; retrieve a first portion of the media data from the first service location via the first transport session; and retrieve a second portion of the media data from the second service location via the second transport session.

Likewise, server device 60 represents an example of a server device for exchanging media data, including: a memory configured to store a media player entry for a media presentation; and a processing system implemented in circuitry and configured to: receive a request for the media player entry from a client device; determine that media data of the media presentation is available from multiple service locations; and send the media player entry for the media presentation to the client device, the media player entry indicating that the media data of the media presentation is available from the multiple service locations.

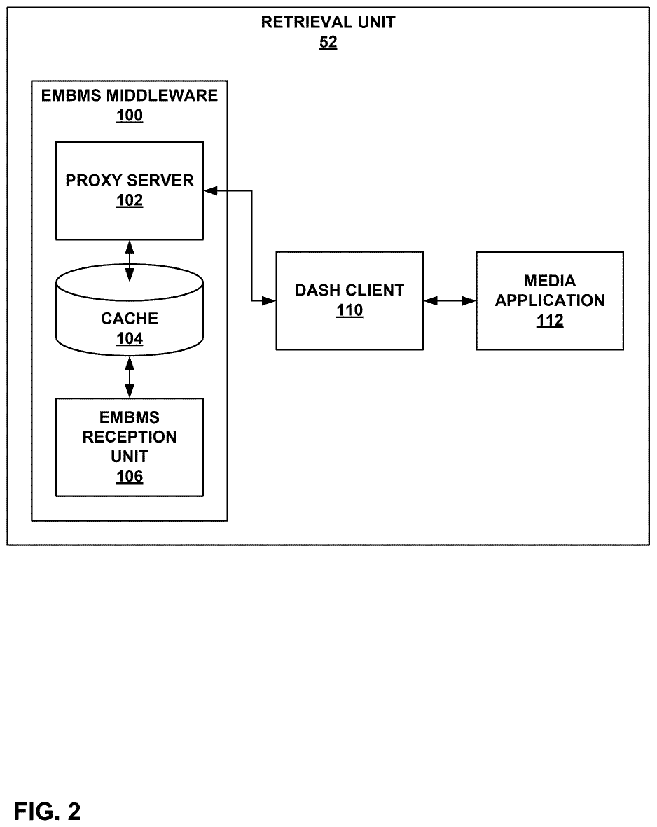

FIG. 2 is a block diagram illustrating an example set of components of retrieval unit 52 of FIG. 1 in greater detail. In this example, retrieval unit 52 includes eMBMS middleware unit 100, DASH client 110, and media application 112.

In this example, eMBMS middleware unit 100 further includes eMBMS reception unit 106, cache 104, and proxy server unit 102. In this example, eMBMS reception unit 106 is configured to receive data via eMBMS, e.g., according to File Delivery over Unidirectional Transport (FLUTE), described in T. Paila et al., “FLUTE-File Delivery over Unidirectional Transport,” Network Working Group, RFC 6726 November 2012, available at tools.ietf.org/html/rfc6726. That is, eMBMS reception unit 106 may receive files via broadcast from, e.g., server device 60, which may act as a broadcast/multicast service center (BM-SC).

As eMBMS middleware unit 100 receives data for files, eMBMS middleware unit may store the received data in cache 104. Cache 104 may comprise a computer-readable storage medium, such as flash memory, a hard disk, RAM, or any other suitable storage medium.

Proxy server unit 102 may act as a server for DASH client 110. For example, proxy server unit 102 may provide a MPD file or other manifest file to DASH client 110. Proxy server unit 102 may advertise availability times for segments in the MPD file, as well as hyperlinks from which the segments can be retrieved. These hyperlinks may include a localhost address prefix corresponding to client device 40 (e.g., 127.0.0.1 for IPV4). In this manner, DASH client 110 may request segments from proxy server unit 102 using HTTP GET or partial GET requests. For example, for a segment available from link http://127.0.0.1/rep1/seg3, DASH client 110 may construct an HTTP GET request that includes a request for http://127.0.0.1/rep1/seg3, and submit the request to proxy server unit 102. Proxy server unit 102 may retrieve requested data from cache 104 and provide the data to DASH client 110 in response to such requests.

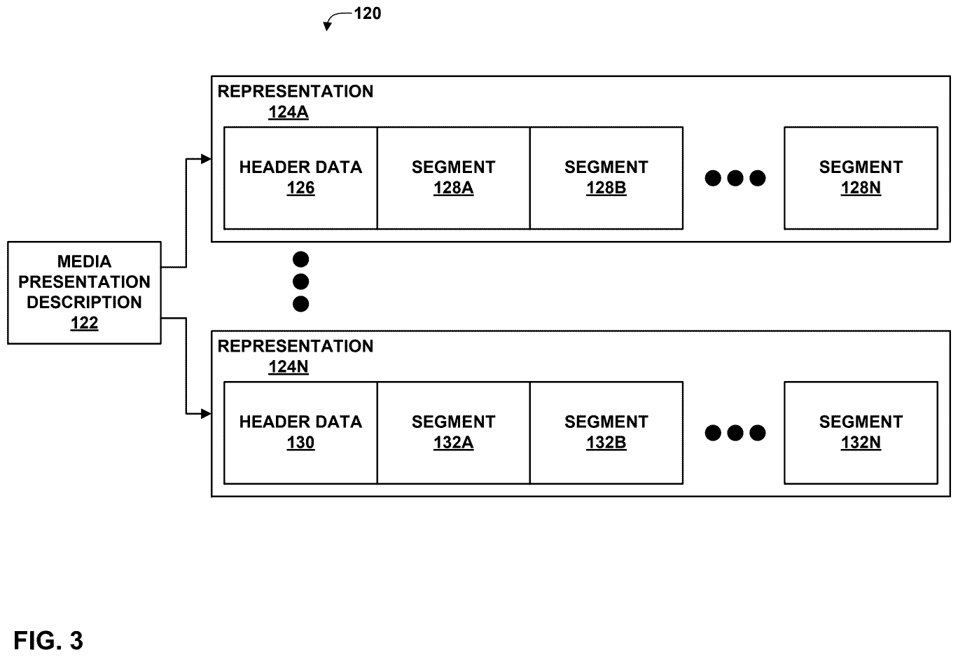

FIG. 3 is a conceptual diagram illustrating elements of example multimedia content 120. Multimedia content 120 may correspond to multimedia content 64 (FIG. 1), or another multimedia content stored in storage medium 62. In the example of FIG. 3, multimedia content 120 includes media presentation description (MPD) 122 and a plurality of representations 124A-124N (representations 124). Representation 124A includes optional header data 126 and segments 128A-128N (segments 128), while representation 124N includes optional header data 130 and segments 132A-132N (segments 132). The letter N is used to designate the last movie fragment in each of representations 124 as a matter of convenience. In some examples, there may be different numbers of movie fragments between representations 124.

MPD 122 may comprise a data structure separate from representations 124. MPD 122 may correspond to manifest file 66 of FIG. 1. Likewise, representations 124 may correspond to representations 68 of FIG. 1. In general, MPD 122 may include data that generally describes characteristics of representations 124, such as coding and rendering characteristics, adaptation sets, a profile to which MPD 122 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 126, when present, may describe characteristics of segments 128, e.g., temporal locations of random access points (RAPs, also referred to as stream access points (SAPs)), which of segments 128 includes random access points, byte offsets to random access points within segments 128, uniform resource locators (URLs) of segments 128, or other aspects of segments 128. Header data 130, when present, may describe similar characteristics for segments 132. Additionally or alternatively, such characteristics may be fully included within MPD 122.

Segments 128, 132 include one or more coded video samples, each of which may include frames or slices of video data. Each of the coded video samples of segments 128 may have similar characteristics, e.g., height, width, and bandwidth requirements. Such characteristics may be described by data of MPD 122, though such data is not illustrated in the example of FIG. 3. MPD 122 may include characteristics as described by the 3GPP Specification, with the addition of any or all of the signaled information described in this disclosure.

Each of segments 128, 132 may be associated with a unique uniform resource locator (URL). Thus, each of segments 128, 132 may be independently retrievable using a streaming network protocol, such as DASH. In this manner, a destination device, such as client device 40, may use an HTTP GET request to retrieve segments 128 or 132. In some examples, client device 40 may use HTTP partial GET requests to retrieve specific byte ranges of segments 128 or 132.

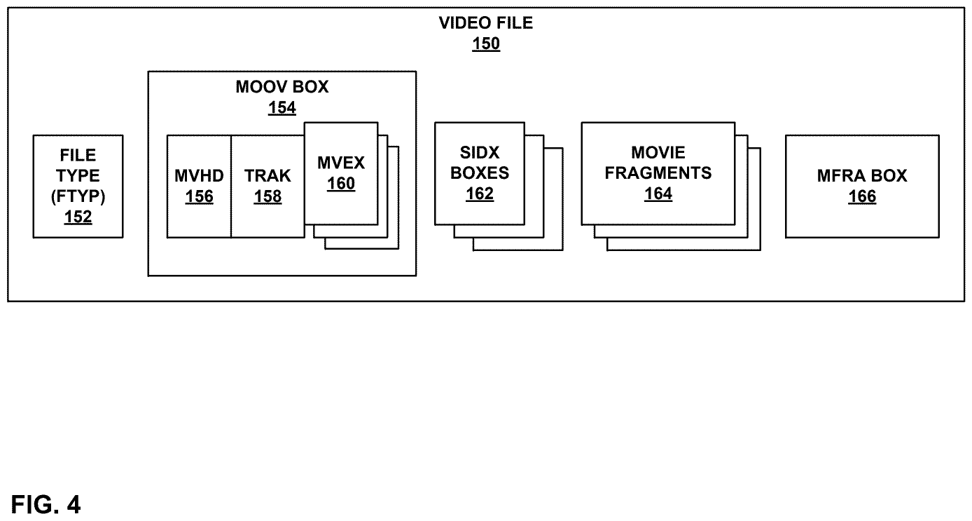

FIG. 4 is a block diagram illustrating elements of an example video file 150, which may correspond to a segment of a representation, such as one of segments 128, 132 of FIG. 3. Each of segments 128, 132 may include data that conforms substantially to the arrangement of data illustrated in the example of FIG. 4. Video file 150 may be said to encapsulate a segment. As described above, video files in accordance with the ISO base media file format and extensions thereof store data in a series of objects, referred to as “boxes.” In the example of FIG. 4, video file 150 includes file type (FTYP) box 152, movie (MOOV) box 154, segment index (sidx) boxes 162, movie fragment (MOOF) boxes 164, and movie fragment random access (MFRA) box 166. Although FIG. 4 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

In some examples, a Segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150.

MOOV box 154, in the example of FIG. 4, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 3) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub) segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 4). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

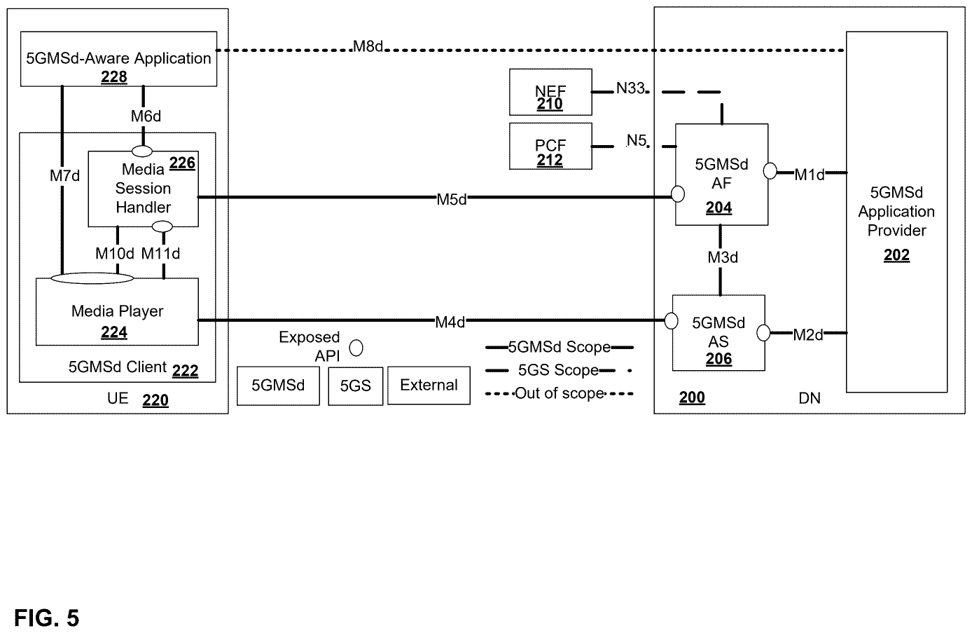

FIG. 5 is a block diagram illustrating an example 5G Media Streaming architecture. The example of FIG. 5 depicts data network (DN) 200, network exposure function 210, policy and charging function (PCF) 212, and user equipment (UE) 220. DN 200 includes 5GMSd Application Provider (AP) 202, 5GMSd Application Function (AF) 204, and 5GMSd Application Server (AS) 206). UE 220 includes 5GMSd client 222, which includes media player 224 and media session handler (MSH) 226, as well as 5GMSd-Aware Application 228.

In this example, UE 220 retrieves media data from DN 200. Media player 224 and media session handler 226 generally communicate with DN 200 to establish a streaming session and to retrieve media data via the streaming session.

Various examples of multi-CDN streaming techniques may be implemented, per techniques of this disclosure. For example, multi-CDN delivery may be performed with DNS-based client-side switching. As another example, multi-CDN delivery may be performed with HTTP streaming (e.g., DASH)-based client-side switching. Such may include usage of multiple BaseURLs and consistent resolution. As yet another example, multi-CDN delivery may be performed with HTTP streaming-based client side switching and with priorities. Furthermore, multi-CDN delivery may be performed with content steering. As still another example, multi-CDN delivery may be performed using Server and Network-Assisted DASH (SAND) for Multi-Network support (SAND4M). Moreover, multi-CDN delivery may be performed in combination with common multisource media format (CMMF).

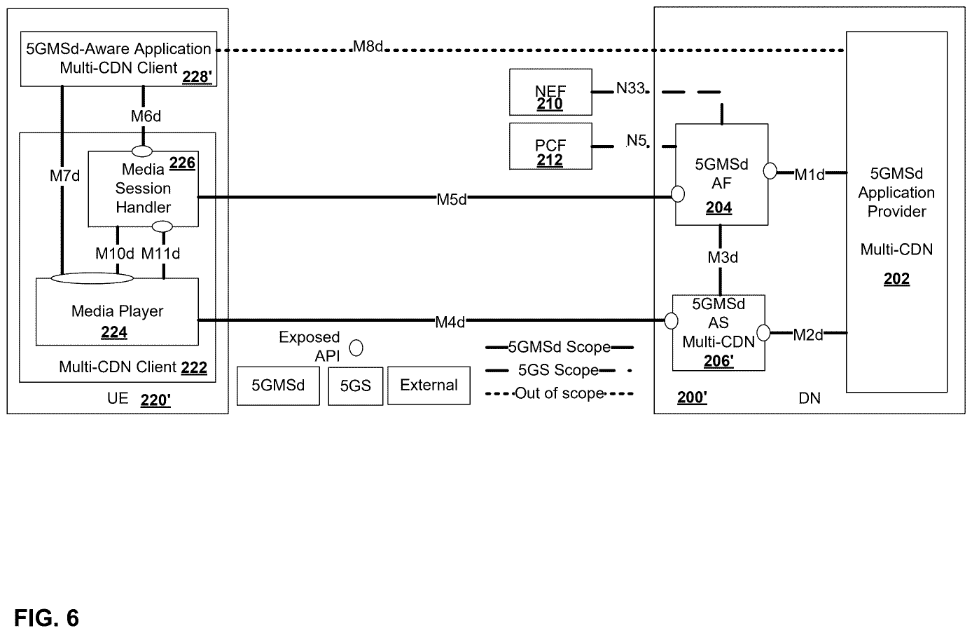

FIG. 6 is a block diagram illustrating an example multi-CDN architecture in which the multi-CDN is a feature of a 5GMS application server (AS) and/or of a 5GMS application provider (AP). In particular, in the example of FIG. 6, many components are similarly named and numbered as in FIG. 5. However, in the example of FIG. 6, DN 200′ includes 5GMSd AS Multi-CDN 206′ and UE 220′ includes 5GMSd-Aware Application Multi-CDN Client 228′.

In some examples, a 5GMSd AS performs active multi-CDN operations. HTTP streaming (e.g., DASH) content may be provided to 5GMSd AS Multi-CDN 206′. 5GMSd AS Multi-CDN 206′ may initiate multi-CDN AS. 5GMSd AS Multi-CDN 206′ may be in a trusted or non-trusted network.

In some examples, multi-CDN hosting may be performed and UE 220′ may be configured to select one or more of the CDNs. 5GMSd AS Multi-CDN 206′ may include multiple service locations in a manifest file (e.g., an MPD), and UE 220′ may determine the multiple service locations from the manifest file.

In some examples, in addition or in the alternative, content steering may be performed. In addition to the components shown in FIG. 6, a content steering server may provide information to UE 220′ regarding selection and use of the multiple service locations.

In some examples, multi-CDN may be performed in accordance with TS 26.247, in which multiple service locations may be advertised in the manifest file (e.g., MPD), and SAND may be used for switching between the CDNs.

In addition or in the alternative, CMMF may be performed in combination with multi-CDN streaming, in which case new content may be created from DASH content and hosted on different CDNs.

In some examples, 5GMSd AS Multi-CDN 206′ may act as an edge cache. In this case, the multi-CDN operation may be performed by the media streaming application. The application may select 5GMSd AS Multi-CDN 206′ as a serving CDN or as an external CDN. There may be two or more “5GMSd ASes.” For example, the 5GMSd AS for each operator may be different. Each 5GMSd AS may host a subset of the media presentation.

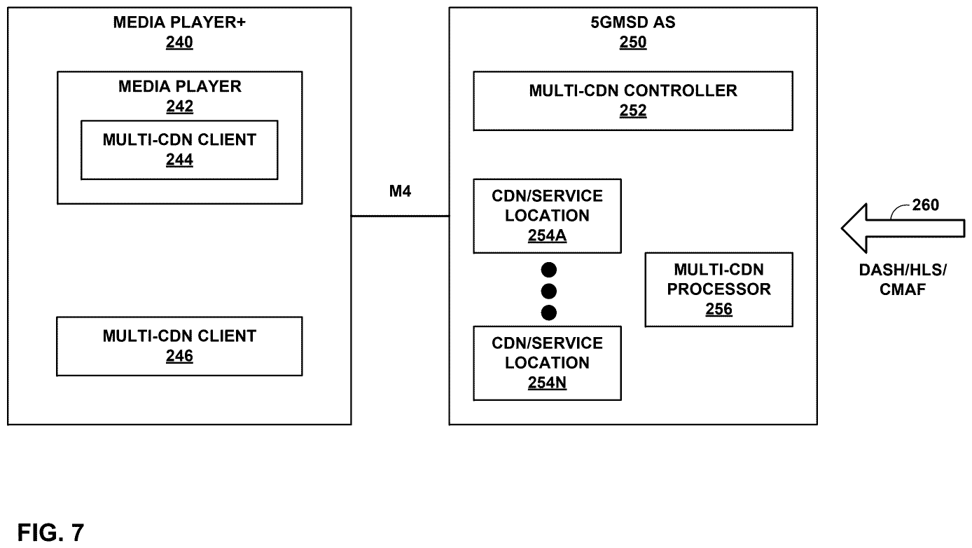

FIG. 7 is a block diagram illustrating an example implementation of multi-CDNs using a 5GMSd with multiple CDNs. The example of FIG. 7 depicts media player⁺ 240, 5GMSd AS 250, and media data such as DASH/HLS/CMAF 260. Media player⁺ 240 includes media player 242 which itself includes multi-CDN client 244, and also multi-CDN client 246. Thus, media player 242 may be considered to be a multi-CDN client-configured media player. 5GMSd AS 250 includes multi-CDN controller 252, multiple CDN/service locations 254A-254N, and multi-CDN processor 256.

An extension to media player⁺ 240 and the player manifest may be created. Additionally or alternatively, a new module may be added to media player⁺ 240 that is initiated with user plane information and interfaces with media player 242 using well-defined APIs.

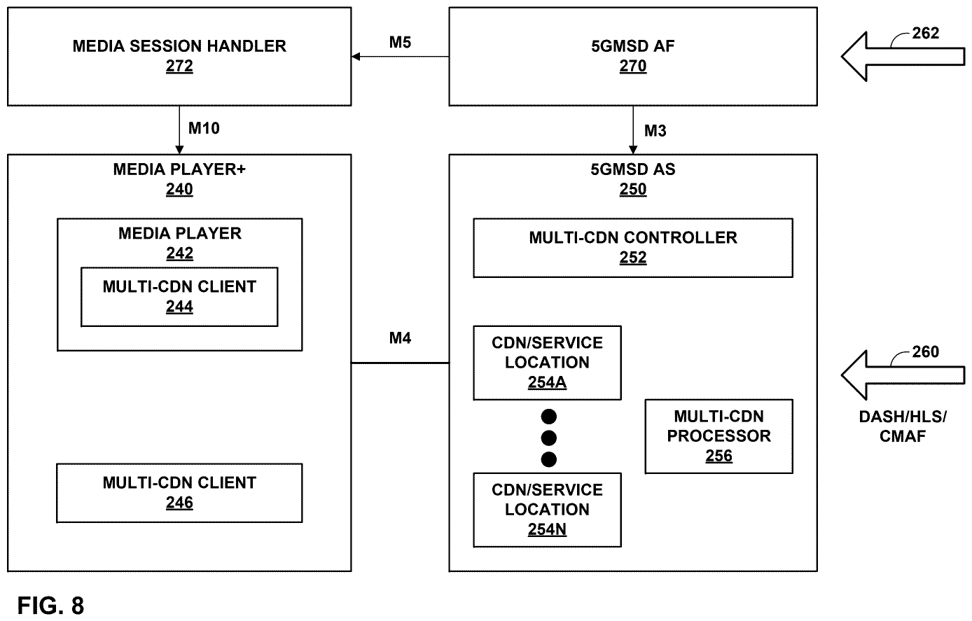

FIG. 8 is a block diagram illustrating another example implementation of multi-CDNs using a 5GMSd with multiple CDNs. Similarly named and enumerated components to those of FIG. 7 generally represent the same functional components and units. In addition to the components of FIG. 7, FIG. 8 depicts media session handler (MSH) 272 communicatively coupled to media player⁺ 240 via an M10 interface, and 5GMSd Application Function (AF) 270 communicatively coupled to 5GMSd AS 250 via an M3 interface and to MSH 272 via an M5 interface.

In this example, 5GMSd AF 270 may receive provisioning information 262, while multi-CDN processor 256 may receive HTTP streaming media data, such as DASH media data, HTTP Live Streaming (HLS) media data, or common media application format (CMAF) media data 260.

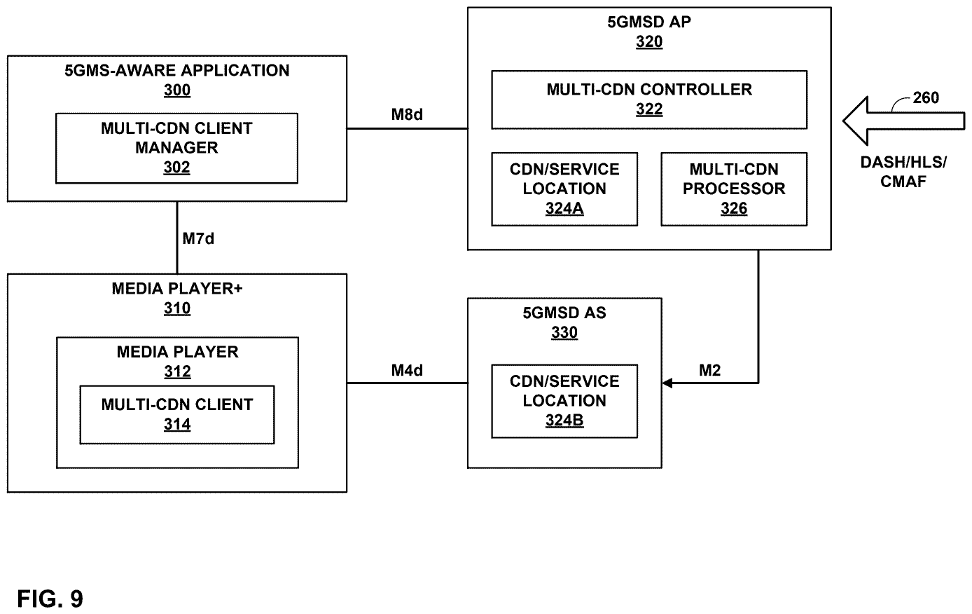

FIG. 9 is a block diagram illustrating an example implementation of multi-CDNs using multiple 5GMSd ASes, each acting as a different CDN or service location. In this example, 5GMSd Application Provider (AP) 320 includes multi-CDN controller 322, CDN/service location 324A (e.g., a 5GMSd AS), and multi-CDN processor 326. Furthermore, in the example FIG. 9, 5GMSd AS 330 includes CDN/service location 324B. FIG. 9 also depicts 5GMS-aware application 300 and media player⁺ 310, where 5GMS-aware application 300 includes multi-CDN client manager 302 and media player⁺ 310 includes media player 312, which includes multi-CDN client 314.

For 5GMS being one service location, most control exchange may happen via an M8d interface between 5GMS-aware application 300 of a UE and 5GMS AP 320. However, instructions to change streaming behavior (such as switching to a new service location) may be provided via an M7d interface between 5GMS-aware application 300 and media player⁺ 310.

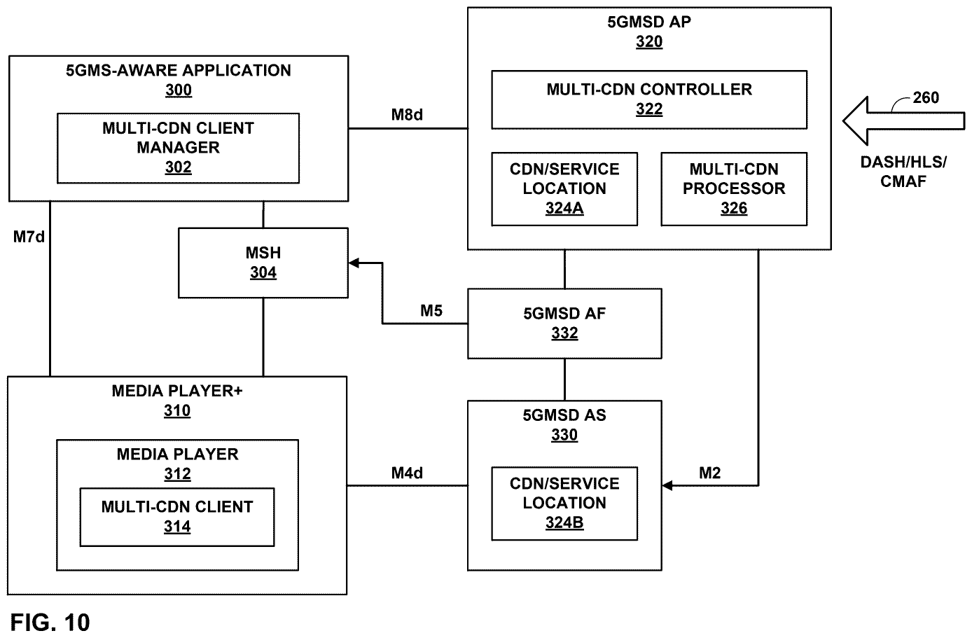

FIG. 10 is a block diagram illustrating another example implementation of multi-CDNs using multiple 5GMSd ASes, each acting as a different CDN or service location. The example of FIG. 10 includes similarly named and enumerated components to those of FIG. 9. In addition, the example of FIG. 10 depicts media session handler (MSH) 304 and 5GMSd AF 332.

In general, for cases where a 5GMSd AS acts as a multi-CDN (e.g., as shown in FIGS. 6-8), the 5GMSd prepares media content (e.g., a media presentation) for multi-CDN delivery. The 5GMSd updates the manifest file to provide multiple service locations, as well as potentially including priority information for the various service locations. The 5GMSd may then publish the content at multiple service locations. The 5GMSd may also establish a processor that manages the multi-CDN content (e.g., a steering server, an MPD rewriter, a SANDer, and so on). The 5GMSd may then publish the manifest file.

The media player may retrieve the manifest file and determine to use the multi-CDN information of the manifest file during media data retrieval. The media player may contact the steering server or SAND server, if any, for streaming information, and retrieve the media data using such information. The media player may download the media data from one of the service locations. The streaming information may be updated based on dynamic information from, e.g., MPD updates, SAND information, or from the content steering server.

The media content may be modified. In such case, 5GMSd AP 320 may add a player entry point to the manifest file. 5GMSd AP 320 may also create multiple copies of each of the segments of media data (e.g., using CMMF encoding). 5GMSd AP 320 may map the redundant copies to a label that can be associated with different MPD URLs (e.g., similar to a file delivery table (FDT) in MBMS/MBS). 5GMSd AP 320 may then upload the redundant copies to the service location. 5GMSd AS 330 may provide configuration to a CMMF module in the client (UE). The CMMF client may request the redundant objects (e.g., on demand or proactively). The CMMF client may then reconstruct the original segments and make them available to the media player.

For cases where content is not modified and the AS hosts received content, 5GMSd AP 320 may prepare content to be distributed via multiple service locations. 5GMSd AP 320 may then provision 5GMS via an M1 interface to host a subset of the content. 5GMSd AP 320 may configure 5GMSd AS 330 accordingly.

The subset of content for a particular 5GMSd AS may be ingested via the M2 interface (e.g., selected representations or a CMMF stripe), as shown in FIGS. 9 and 10. Each 5GMSd AS (such as 5GMSd AS 330) may act as one service location for the application service provider (such as 5GMSd AP 320).

Media player⁺ 310 may be 5GMS-aware, but media player⁺ 310 may receive content partially via the M4 interface (managed) and partially via the M8 interface. Configuration of media player⁺ 310 and selection data may be provided by 5GMS-aware application 300. 5GMSd AF 332 AF may be involved in managing the M4 delivery of media data.

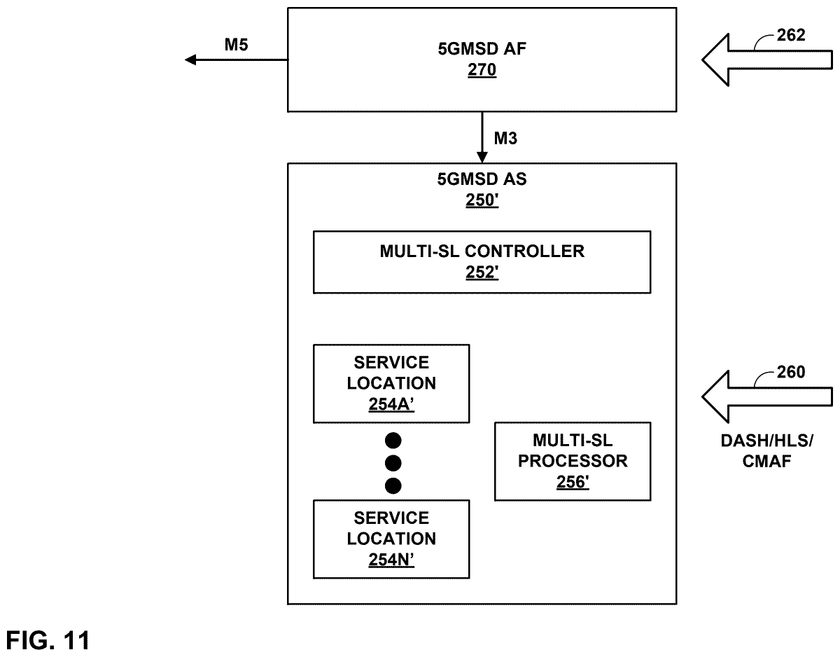

FIG. 11 is a block diagram illustrating an example architecture for a 5GMSd AS to act as a multiple service location host. The various components of FIG. 11 are similar to the corresponding components of FIG. 8. However, rather than explicitly using CDNs, FIG. 11 indicates that other service locations may be used aside from CDNs. Thus, FIG. 11 depicts 5GMSd AS 250′ ass including multi-service-location (multi-SL) controller 252′, service locations 254A′-254N′, and multi-SL processor 256′.

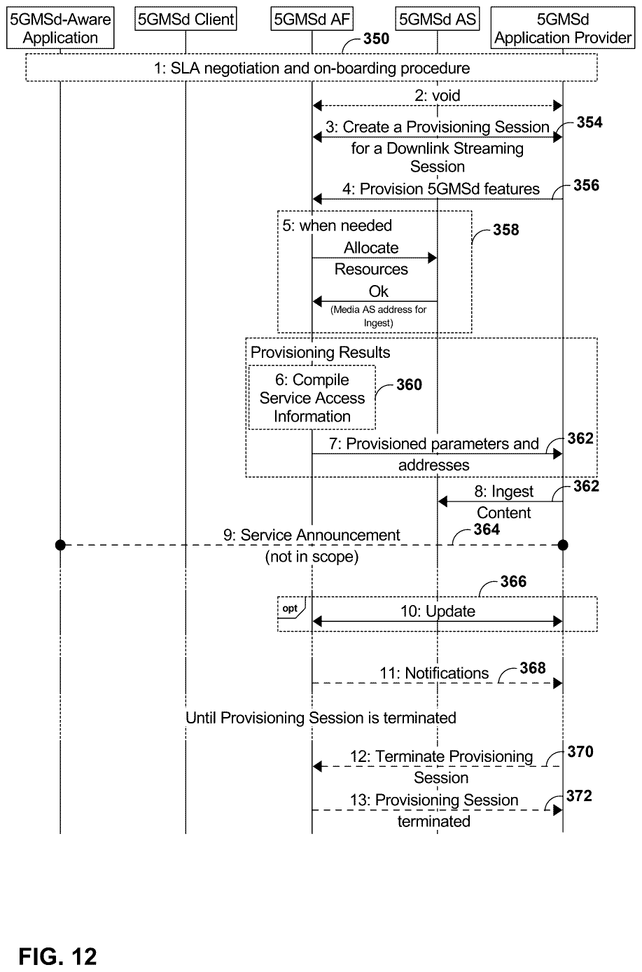

FIG. 12 is a call flow diagram in which a 5GMSd AS, such as 5GMSd AS 250′ of FIG. 11, acts as a multiple service location host. The 5GMSd AS and UE/5GMSd client may exchange multi-service location provisioning parameters to use multiple service location streaming per techniques of this disclosure. The provisioning parameters may include a request for using multiple service locations, multi-service location processing (e.g., a detailed content preparation template may be provided to the AS), parameters representing features to be used (e.g., client selection, content steering, SAND4M, and/or CMMF with configuration parameters), and/or number of service locations and parameters for each service location. The service location parameters may be associated with different QoS parameters, host different slices, and/or be configured with other differentiating aspects. In some examples, the AS may also be informed of existing service locations that are outside of the 5GMS and may provide policies on how to use these other service locations.

In some examples, the 5GMSd AS may also receive information representing existing service locations that are external to the 5GMS system. For instance, the provisioning parameters may identify one or more external CDNs or other content hosts. In such cases, the provisioning parameters may also include policies that instruct the 5GMSd AS on how to interact with or direct a client device to use these external service locations, for example, as fallback options, for specific content types, or based on network conditions.

Initially, a 5GMSd Application Provider and a 5GMSd AS may perform a Service Level Agreement (SLA) negotiation and on-boarding procedure (350). The 5GMSd Application Provider may then initiate a provisioning session by sending a request to a 5GMSd AF to create a provisioning session for a downlink streaming session (354).

In response, the 5GMSd AF provisions 5GMSd features to the 5GMSd AS (356). These provisioning parameters may specify the use of multiple service locations and may include details for multi-service location processing, parameters for features like client selection, content steering, SAND4M, and/or Common Multisource Media Format (CMMF), along with the number of service locations and their individual parameters. The service location parameters may be associated with different Quality-of-Service (QoS) levels, different network slices, and/or other differentiating aspects. In some examples, the 5GMSd AS may also be informed of existing service locations outside of the 5GMS and be provided with policies on how to use them.

When needed, the 5GMSd AF and 5GMSd AS may perform resource allocation (358), which results in the 5GMSd AS providing a Media AS address for content ingestion to the 5GMSd AF. The 5GMSd AF may compile the service access information (360) and send the provisioned parameters and addresses back to the 5GMSd Application Provider (362). Using this information, the 5GMSd Application Provider ingests the media content to the 5GMSd AS (364).

The 5GMSd AP may then provide a service announcement to a 5GMSd-Aware Application on a client device (step 9). During the session, the 5GMSd Application Provider may optionally send updates to the 5GMSd AF (366), and the 5GMSd AF may send notifications back to the 5GMSd Application Provider (368), e.g., to confirm receipt of the update. This cycle can continue until the provisioning session is terminated.

To end the session, the 5GMSd Application Provider may send a request to the 5GMSd AF to terminate the provisioning session (370). The 5GMSd AF may then confirm that the session is terminated (372).

The call flow diagram of FIG. 12 is generic to address client selection, content steering, and SAND4M techniques, along with multiple service locations.

In this manner, the method of FIG. 12 represents an example of a method of retrieving media data, including: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations. The method may further include establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

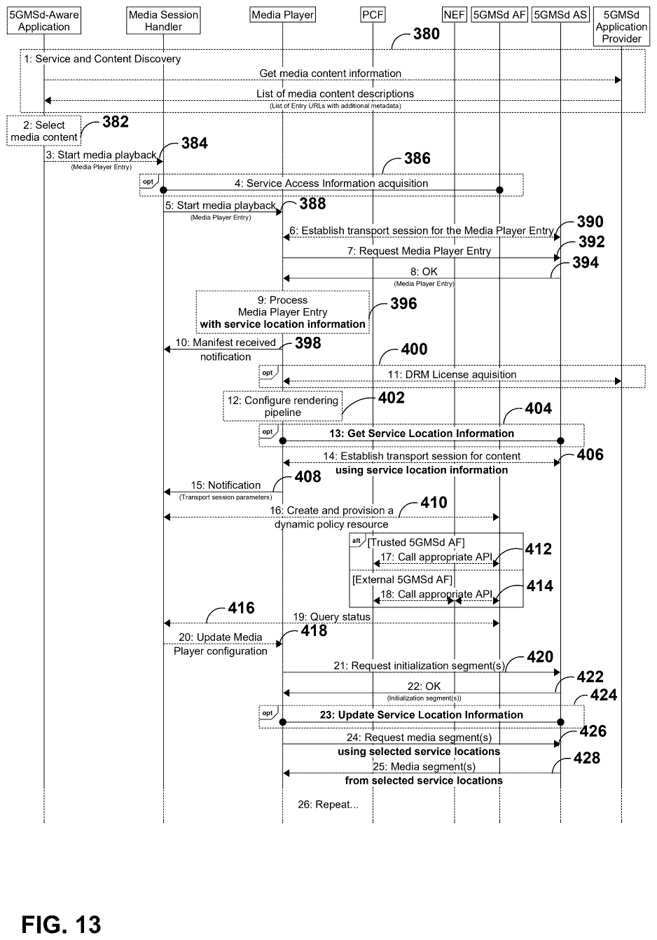

FIG. 13 is a call flow diagram illustrating an example method for performing multiple service location streaming using a 5GMSd AS as a multiple service location host. In this example, the media player entry (which may be included in a manifest file, such as a media presentation description (MPD)) includes information about multiple service locations. The media player processes the multiple service location data. The media player may retrieve multiple service location information from the AS. The media player may use this multiple service location information to establish a transport session with the AS.

When accessing segments, the media player may use selected service locations. When accessing segments and media entries, new information may be provided. Additionally or alternatively, the new information may be provided via an update to the media player entry. Service location information may be exchanged with the media session handler (MSH), e.g., to address the selection of service locations.

In the example of FIG. 13, initially, the 5GMSd-Aware Application performs service and content discovery (380). The 5GMSd-Aware Application may, for example, request media content information (e.g., in the form of media player entry) from the 5GMSd Application Provider (AP), and the 5GMSd AP may send the media player entry including a list of media content descriptions. The media content descriptions may include a list of Entry URLs for the media data, as well as additional metadata.

The 5GMSd-Aware Application may then select the desired media content (382). The 5GMSd-Aware Application may then initiates media playback by providing the media player entry to the Media Session Handler (384). The MSH may acquire service access information from the 5GMSd AF (386) and, in turn, instructs the media player to start playback using the Media Player Entry (388).

The media player may then establish a transport session for the media presentation using the media player entry with the 5GMSd AS (390) and requests a specific media player entry for that transport session (392). After receiving an acknowledgement (“OK”) response for the media player entry from the 5GMSd AS (394), the media player may process the media player entry, which contains service location information (396). The media player may then send a notification to the MSH indicating the manifest (that is, the media player entry) has been received (398). After optional DRM license acquisition (400), the media player may configure its rendering pipeline (402).

The media player may then retrieve specific service location information from the 5GMSd AS (404) and establish a new transport session for the content using this information (406). The MSH receives a notification with transport session parameters (408) from the media player and proceeds to create and provision a dynamic policy resource by interfacing with the 5GMSd AF (410). In some examples, a trusted 5GMSd AF may call an appropriate API of a policy and charging function (PCF) (412), or an external 5GMSd AF may call an appropriate API of the PCF via a network exposure function (NEF) (414).

After querying the status (416), the MSH updates configuration of the media player (418). The media player may then request (420) and receive (422) initialization segments from the 5GMSd AS. This may proceed while media data of the media presentation remains to be collected.

In some cases, the client device may receive an update to the service location information (424). In response, the client device may subsequently request media segments from the selected service locations (426) and receive the requested segments in response (428).

This process of requesting and receiving segments can then be repeated for the duration of the media session.

In this manner, the method of FIG. 13 represents an example of a method of retrieving media data, including: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations. The method may further include establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

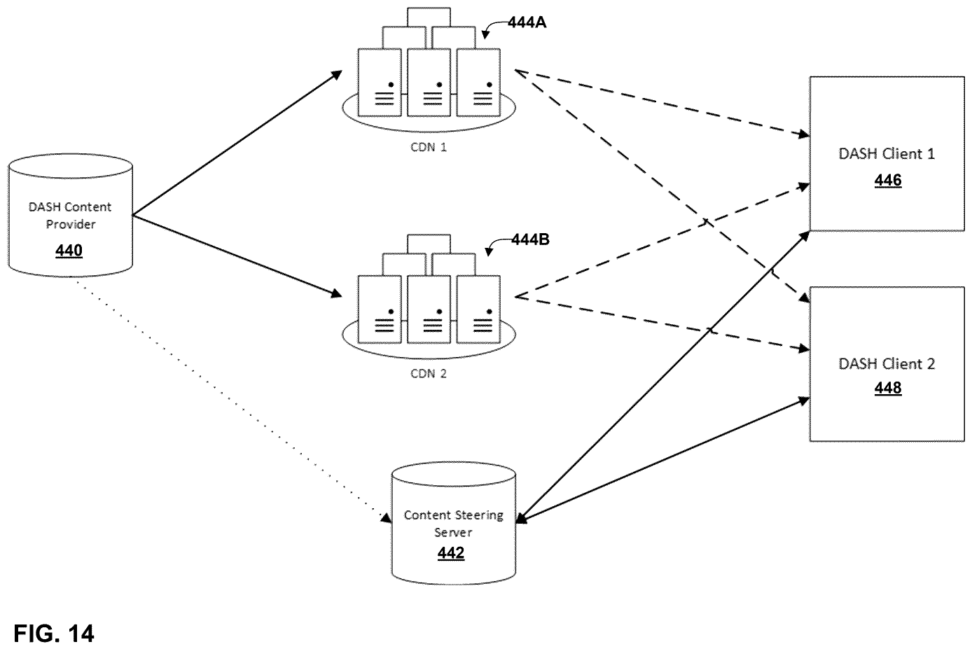

FIG. 14 is a block diagram illustrating an example content steering architecture. The example of FIG. 14 depicts DASH content provider 440, CDNs 444A, 444B, content steering server 442, and DASH clients 446, 448. In this example, DASH content provider 440 provides content to CDNs 444A, 444B, as well as data representing the CDNs to content steering server 442. DASH clients 446, 448 may use content steering server 442 to select one of the various CDNs 444A, 444B from which to retrieve media data.

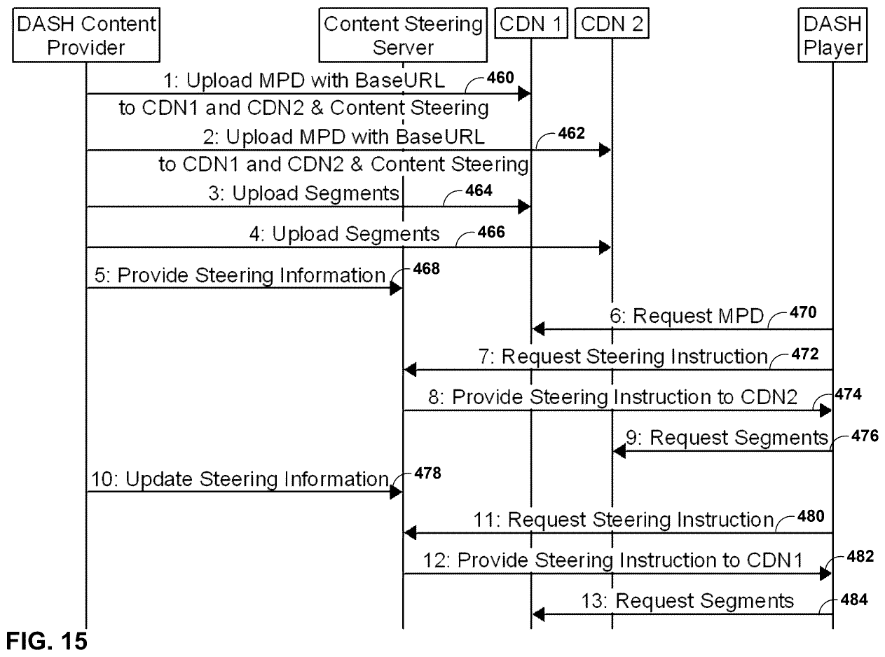

FIG. 15 is a call flow diagram illustrating an example method for retrieving media data from multiple CDNs using a content steering server, e.g., per the architecture of FIG. 14. In general, the media player (e.g., a DASH player) may request steering information from the content steering server to determine which CDN should be used to retrieve media data of a media presentation. The content steering server may provide different selection indications over time, e.g., due to varying network bandwidth conditions or operational performance of the CDNs.

Initially, a DASH content provider (e.g., DASH content provider 440, which may correspond to a 5GMSd AP as discussed above) provides a media player entry (e.g., a manifest file, such as an MPD) to both CDN 1 (e.g., CDN 444A) (460) and CDN 2 (e.g., CDN 444B) (462), where the media player entry includes respective BaseURLs for the CDNs and content steering information. The DASH content provider may then upload segments of media data of a media presentation to CDN 1 (464) and CDN 2 (466). The DASH content provider may also provide steering information to the content steering server (e.g., content steering server 442) (468).

A DASH player (e.g., a media player of a UE) may then request the media player entry from one of the CDNs (470). The DASH player may also request steering instructions from the content steering server (472). In response, the content steering server may provide steering instructions for requesting media data from, in this example, CDN 2 (474), e.g., based on current network conditions, load balancing, distance between the DASH player and CDNs 1 and 2, or the like. Accordingly, based on the instructions from the content steering server, the DASH player may request segments of the media presentation from CDN 2 (476).

At some point, the DASH content provider may update the steering information (478) to the content steering server. Thus, in response to a later request for steering instructions from the DASH player (480), the content steering server may provide a steering instruction to request media data from CDN 1 to the DASH player (482). Accordingly, the DASH player may, in response, request segments of media data of the media presentation from CDN 1 (484).

In this manner, the method of FIG. 15 represents an example of a method of retrieving media data, including: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations. The method may further include establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

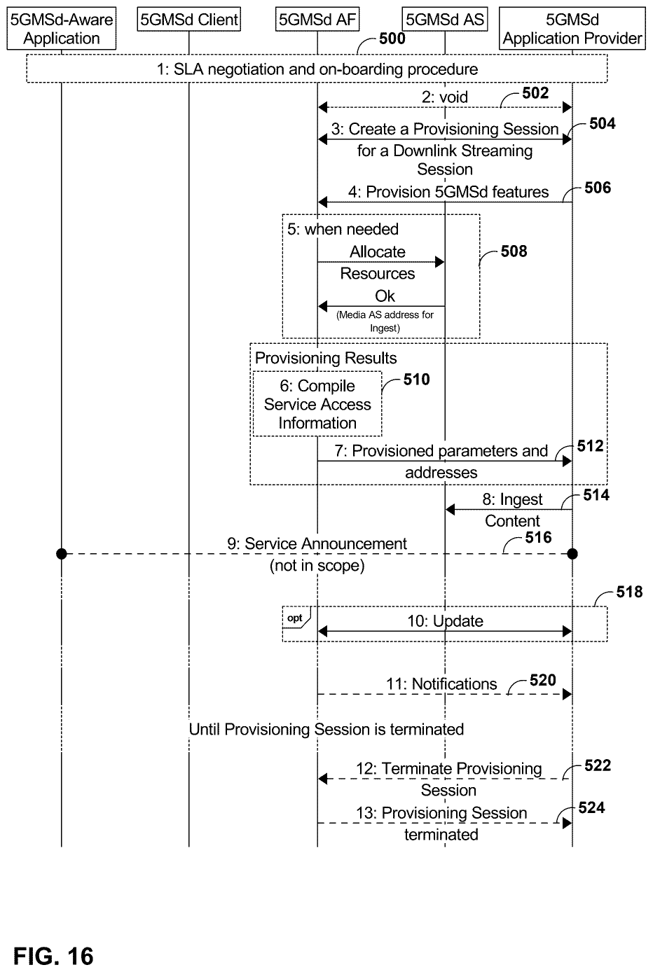

FIG. 16 is a call flow diagram illustrating an example method including updates to incorporate a 5GMSd AS into the architecture of FIG. 14. Such updates include use of provisioning parameters. These provisioning parameters may include a request for using multiple service locations (e.g., distribution of resources, whether the resources are copies, which selected content is available from which service location, etc., as well as a manifest file for the media presentation). The provisioning parameters may also include a request for adding a content steering server with parameters, including a steering update frequency (e.g., how frequently the content steering server should be contacted to update a service location selection). The provisioning parameters may further include a number of service locations and parameters for each service location. Each service location may be associated with different QoS parameters, a different slice, and/or other differentiating aspects.

In some examples, the AS may also receive information regarding existing service locations that are outside of the 5GMS and may provide policies on how to use these service locations. The provisioning parameters may also include information on how the content steering server may be used. Such content steering techniques may be used with various streaming techniques, such as DASH and/or HLS.

The method of FIG. 16 is explained with respect to a 5GMSd Application Provider, a 5GMSd Application Server (AS), a 5GMSd Application Function (AF), a 5GMSd Client, and a 5GMSd-Aware Application. This method multi-service location techniques of this disclosure in the form of one or more 5GMSd ASes into an architecture like the architectures shown in, e.g., FIGS. 6-11 and 14.

Initially, the 5GMSd Application Provider and the 5GMSd AS may perform a Service Level Agreement (SLA) negotiation and on-boarding procedure (500). The 5GMSd AF and the 5GMSd AP may exchange a void message (502). Following this, the 5GMSd AP may initiate a provisioning session by sending a request to the 5GMSd AF to create a provisioning session for a downlink streaming session (504).

In response, the 5GMSd AP provisions 5GMSd features to the 5GMSd AF (506). Provisioning parameters of the provisioned 5GMSd features may include a request for using multiple service locations, a request for adding a content steering server with associated parameters, and the number of service locations with parameters for each. For instance, a parameter may define the steering update frequency, which may indicate how often the content steering server should be contacted to update a service location selection. The service location parameters may be associated with different Quality of Service (QoS) levels, different network slices, or other differentiating aspects.

When needed, the 5GMSd AF may request that the 5GSMd AS allocate resources (508) for the downlink streaming session, in response to which, the 5GMSd AS may return a Media AS address for content ingestion to the 5GMSd AF. The 5GMSd AF may then compile the service access information (510) and send the provisioned parameters and addresses (e.g., URLs of 5GMSd ASes acting as service locations) back to the 5GMSd Application Provider (512).

Using this information, the 5GMSd Application Provider may ingest media content to the 5GMSd ASes (514). The 5GMSd AP may then send a service announcement to the 5GMSd-Aware Application on a client device (516).

During the downlink media streaming session, the 5GMSd Application Provider may optionally send updates to the 5GMSd AF (518) e.g., to update provisioned resources for the downlink streaming session (e.g., to activate or deactivate 5GMSd ASes/service locations). The 5GMSd AF may send notifications back to the 5GMSd Application Provider (520) when such provisioning has been updated. This cycle may continue until the provisioning session is terminated. To end the session, the 5GMSd Application Provider may send a request to the 5GMSd AF to terminate the provisioning session (522), and the 5GMSd AF confirms that the session is terminated (524).

In this manner, the method of FIG. 16 represents an example of a method of retrieving media data, including: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations. The method may further include establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

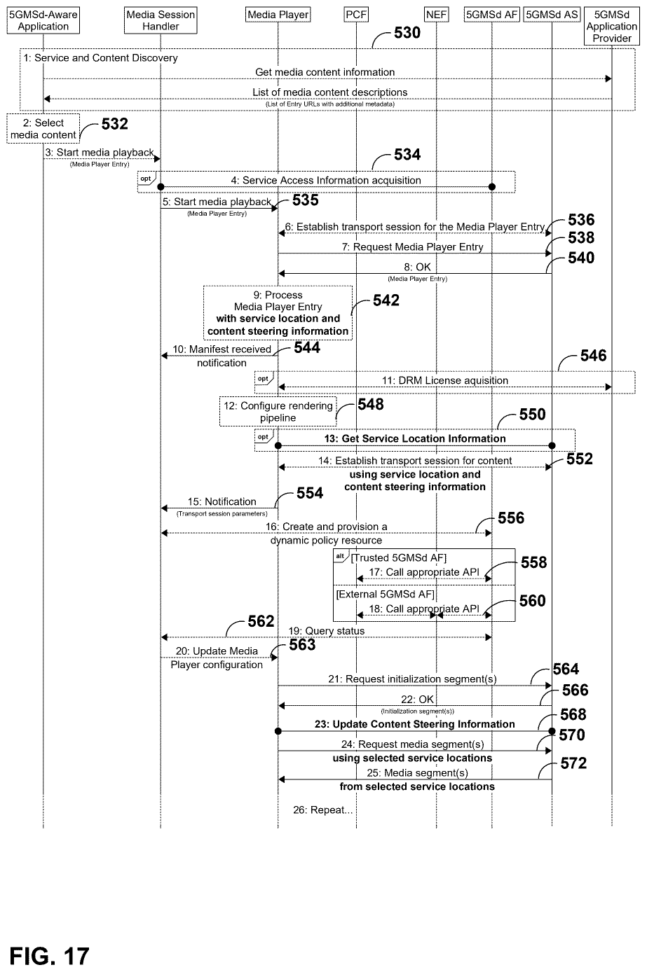

FIG. 17 is a call flow diagram illustrating a method of using a content steering server for multiple service locations according to techniques of this disclosure. A media player entry (which may be included in a manifest file, such as an MPD) may include information about the multiple service locations and the content steering server. The media player may process the information on the content steering server and multiple service location data. The media player may use this information to establish one or more transport sessions. When accessing segments of the media data, the media player may use selected service locations. When accessing segments and media entries, new information may be provided (e.g., in the form of updates to the media player entry). Updated content steering information may be provided by the AS to the media player. The media player may use this information when requesting segments that are available from different content locations (e.g., different CDNs).

ETSI TS 103 973 v1.1.1 defines a content delivery based instantiation in Annex D. CMMF is considered as a content delivery protocol (CDP) as defined in clause 8 of RFC 5052. Annex D of ETSI TS 103 973 provides a mapping between CMMF and RFC 5052 principles. This instantiation also permits re-use of existing forward error correct (FEC) codes, including Raptor (3GPP MBMS code), as defined in RFC 5053 and RaptorQ as defined in RFC 6330. The protocol also uses 3GPP familiar concepts, such as the File Delivery Table in FLUTE, which is also used in MBMS and MBS.

Initially, a 5GMSd-Aware Application on a client device performs service and content discovery by communicating with a 5GMSd Application Provider (530). For instance, the 5GMSd-Aware Application may request media content information and receive a list of media content descriptions, which can include entry URLs and other metadata. The 5GMSd-Aware Application then selects the desired media content (532), e.g., based on a user selection, device capabilities (decoding and/or rendering capabilities), network conditions, or the like.

The MSH may optionally perform a service access information acquisition step by communicating with the 5GMSd Application Function (AF) (534). After content selection, the 5GMSd-Aware Application starts the media playback process by sending the Media Player Entry to the Media Session Handler (MSH) (535).

The media player may then establish a transport session with the 5GMSd Application Server (AS) to retrieve the media player entry (536) and then request that media player entry (538). The 5GMSd AS may respond with an “OK” response containing the requested media player entry (540). The media player may then process the media player entry to extract the service location and content steering information, such as a BaseURL for a corresponding 5GMSd AS (542). Once the media player entry (e.g., manifest) is processed, the media player may send a “Manifest received” notification to the MSH (544). The media player may then perform an optional Digital Rights Management (DRM) license acquisition with the 5GMSd Application Provider (546) and configure its internal rendering pipeline (548).

Using the information obtained from the manifest, the media player may optionally get specific service location information from the 5GMSd AS (550) and then establish a transport session for the media data of the media presentation using that service location and content steering information (552). The media player may send a notification with the transport session parameters to the MSH (554). The MSH may then create and provision a dynamic policy resource with the 5GMSd AF (556). In some examples, depending on the configuration, a trusted 5GMSd AF may call an appropriate API of the Policy and Charging Function (PCF) directly (558), or an external 5GMSd AF may call an appropriate API via the Network Exposure Function (NEF) (560). After the MSH queries the status of the policy provisioning (562), it updates the Media Player's configuration (563).

The Media Player begins media retrieval by requesting initialization segment(s) from the 5GMSd AS (564), which the 5GMSd AS provides (566). During the session, the 5GMSd AS may optionally send updated content steering information to the Media Player (568). The Media Player may use this steering information to request media segments from the appropriate, selected service locations (570). The 5GMSd AS may respond with the requested media segment(s) (572). This process of requesting and receiving media segments may continue to repeat for the duration of the media session.

In this manner, the method of FIG. 17 represents an example of a method of retrieving media data, including: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations. The method may further include establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

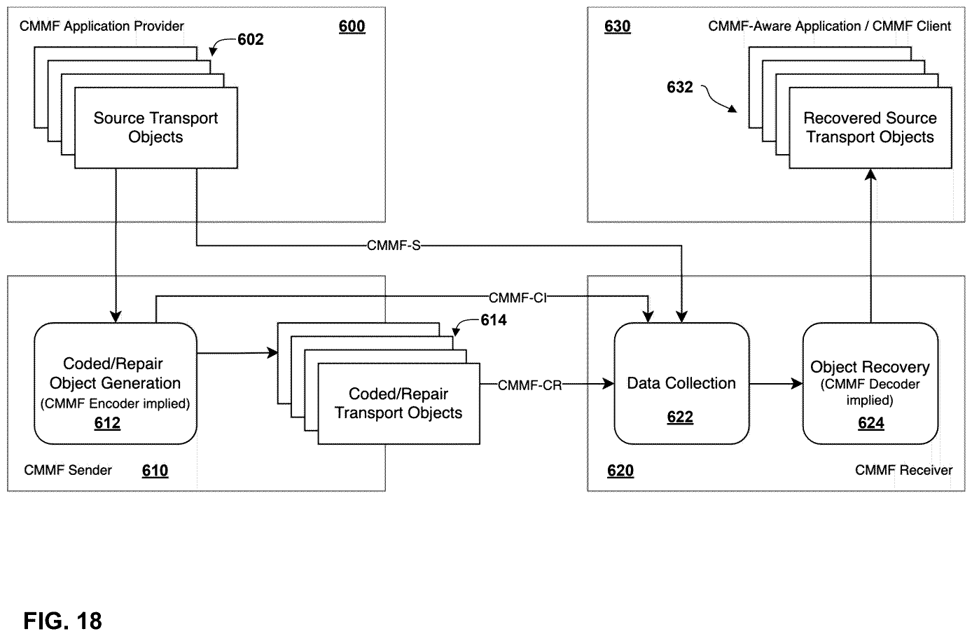

FIG. 18 is a block diagram illustrating an example CMMF architecture. The example of FIG. 18 depicts CMMF application provider 600, CMMF sender 610, CMMF-aware application/CMMF client 630, and CMMF receiver 620. CMMF application provider 600 sends source transport objects 602 to CMMF sender 610. CMMF sender 610 includes a coded/repair object generation unit 612 that generates coded/repair transport objects 614 from source transport objects 602. CMMF sender 610 sends coded/repair transport objects 614 to CMMF receiver 620. CMMF receiver 620 includes data collection unit 622 and object recover unit 624. Data collection unit 622 receives coded/repair transport objects 614 and provides coded/repair transport objects 614 to object recovery unit 624. Object recovery unit 624 reconstructs the transport objects and provides recovered source transport objects 632 to CMMF-aware application/CMMF client 630.

In this example, a CMMF-CI provides configuration information describing a location and a relationship between the source and coded/repair objects, which may be provided to a CMMF receiver.

In this example, CMMF-S provides source transport objects. For CMMF, these source transport objects are unmodified from the original data. Parts of these objects may be used by object recovery to recover the source objects.

In this example, CMMF-CR provides coded/repair transport objects.

Although not explicitly shown in FIG. 18, additionally, server-side configuration of the CMMF sender and a client-side API between the CMMF receiver and the application may be provided.

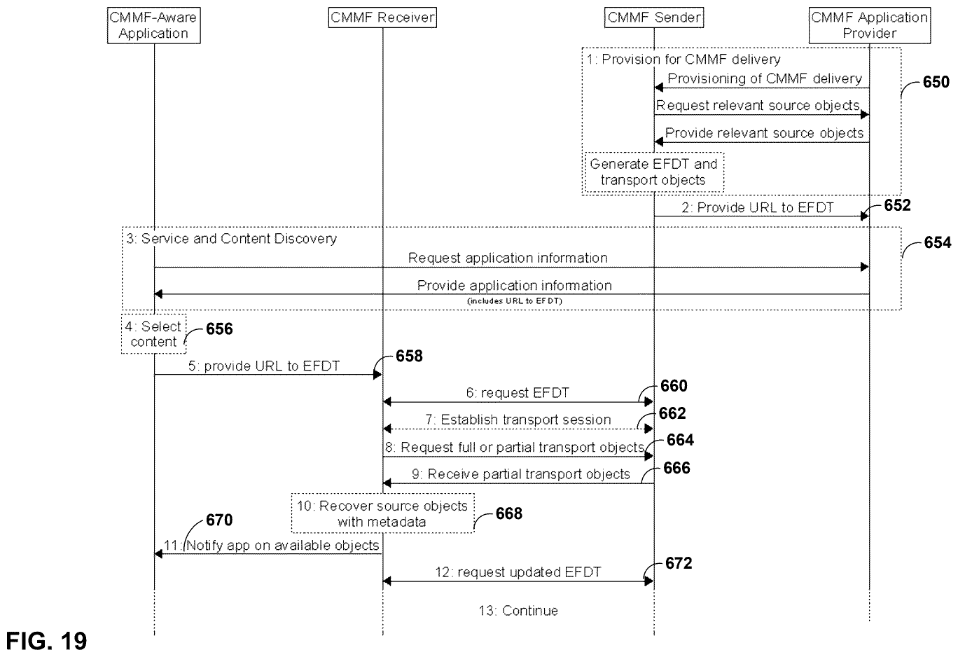

FIG. 19 is a call flow diagram illustrating an example FLUTE-based CMMF CDP instantiation. The example method of FIG. 19 may be used for a File Delivery over Unidirectional Transport (FLUTE)-based Common Multisource Media Format (CMMF) Content Delivery Protocol (CDP) example, according to techniques of this disclosure. The method of FIG. 19 is explained with respect to a CMMF-Aware Application, a CMMF Receiver, a CMMF Sender, and a CMMF Application Provider.

Initially, the CMMF Application Provider and the CMMF Sender engage in a provisioning process for CMMF-based delivery (650). This process may include the provisioning of the CMMF delivery service. After provisioning, the CMMF Sender may request and receive the relevant source objects from the CMMF Application Provider. The CMMF Sender may then generate an Extended File Delivery Table (EFDT) and the necessary transport objects from the source objects (650). The CMMF Sender may provide the CMMF Application Provider with a URL pointing to the newly created EFDT (652).

The CMMF-Aware Application may then perform service and content discovery with the CMMF Application Provider. The CMMF-aware application may request application information, and the CMMF application provider may respond with this information, which may include the URL to the EFDT. Based on this information, the CMMF-aware application may select the desired content (656), e.g., based on a user selection and device capabilities, and provides the URL for the EFDT to the CMMF Receiver (658).

Using the provided URL, the CMMF receiver may request the EFDT from the CMMF Sender (660) and may establish a transport session (662). The CMMF receiver may then request full or partial transport objects from the CMMF sender (664), which the CMMF sender provides in response (666). In response to receiving the transport objects, the CMMF Receiver may recover the source objects along with their metadata (668). The CMMF receiver may then notify the CMMF-Aware Application about the available objects (670). This process can continue throughout the media session, with the CMMF receiver requesting an updated EFDT as needed to discover new or changed content (672).

In this manner, the method of FIG. 19 represents an example of a method of retrieving media data, including: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations. The method may further include establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

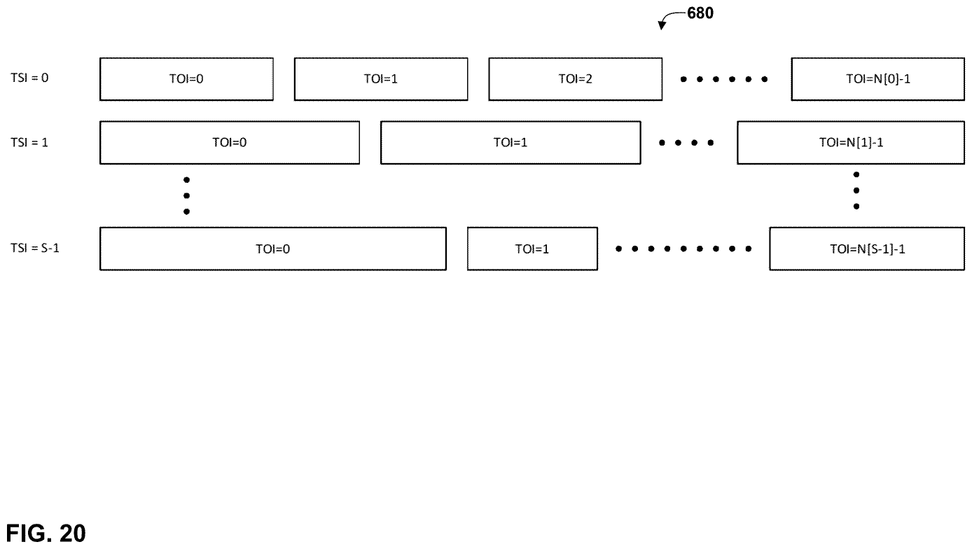

FIG. 20 is a conceptual diagram illustrating an example set of CMMF transport objects 680 and transport sessions. Source and repair objects may be assigned to TSI and TOI. Information may be provided to the receiver through configuration that describes each logical flow that is operated, each object, metadata of the object, and other information, and the type of the object and encoding parameters.

Configuration parameters may be included in configuration information that allows the CMMF client to map an application request to CMMF receiver operations. The table below provides examples of possible configuration information that can be used where source and coded/repair transport objects are described.

| Parameter | Usage | Definition |
|---|---|---|
| Complete | OD | Indicates whether the Configuration |
| | | Information is complete. |
| Location | O | Provides information where the |
| | | Configuration Information can be |
| | | accessed in carried externally. |
| Expires | M | Provides information when this |
| | | Configuration Information is no longer |
| | | valid and an update is needed, for |
| | | example using a reload from Location. |
| Source Flow | 1 . . . S | Provides 1 . . . S source flows. |
| TSI | M | Identifier of the source flow. |
| Object | 1 . . . N | Provides 1 . . . N objects in the source |
| | | flow. |
| TOI | M | Transport object identifier (TOI) value |
| | | that represents the source object. |
| Size | M | Size of the transmission object in bytes. |
| Content-Type | | Describes media type of file. |
| Encoding | | Describes encoding of file. |
| Message Digest | | Message digest of file. |
| Associated URI | | Name, Identification, and Location of |
| | | file (specified by the URI). |
| Access URL | | The URL where the source object can |
| | | be accessed. If the field is not present, |
| | | then the source flow is not directly |
| | | accessible. |
| availabilityStartTime | | Provides a wall-clock time when the |
| | | resource is accessible. |
| availabilityStartTime | | Provides a wall-clock time when the |
| | | resource ceases to be available. |
| <Additional | | May include cache or E-Tag metadata. |
| metadata> | | |
| Representation | | Refers to a DASH Representation in an |
| | | MPD or a Track in an HLS manifest. |
| Coded/Repair Flow | 1 . . . R | Provides 1 . . . R coded/repair flows. |
| TSI | M | Identifier of the coded/repair flow. |
| Object | 1 . . . N | Provides 1 . . . N objects in the |
| | | coded/repair flow. |
| TOI | M | Transport object identifier (TOI) value |
| | | that represents the coded/repair object. |
| FEC-OTI | | If object is coded using a scheme based |
| | | on [RFC5052], FEC Object |
| | | transmission information including the |
| | | FEC Encoding ID and, if relevant, the |
| | | FEC Instance ID. |
| includedSourceTOI | M | List of (TSI, TOI pairs) of the included |
| | | source transport objects forming super |
| | | objects. |
| | | Typically, only a single pair is |
| | | provided. |
| Content-Type | | Media Mime Type of the file. |
| completeObject | OD | Indicates whether the transport object |
| | FALSE | includes sufficient information to |
| | | recover all files included in this |
| | | coded/repair object. |
| symbolArrangement | | Provide this symbol arrangement in the |
| | | object according to Table 78. If not |
| | | present, the symbol Arrangement is |
| | | unknown and only present in the |
| | | bitstream. |
| sAParameters | | may be present if the |
| | | symbolArrangement is present. If |
| | | present, it provides the parameters |
| | | assigned to the symbol arrangement as |
| | | defined in Table 36. For arrangement 2 |
| | | and 3, this is a comma-separated list of: |
| | | Index difference, Symbol group, Index |
| | | in symbol group |
| Access URLs | | The URLs where the coded/repair |
| | | object can be accessed. |
| availabilityStartTime | | Provides a wall-clock time, when the |
| | | resource is accessible. |
| availabilityEndTime | | Provides a wall-clock time, when the |
| | | resource ceases to be available. |
| <Additional | | |
| metadata > | | |

Some use cases may require additional information or only a subset of this information, and a simpler version of this parameter set may be used. Updates to the configuration information may also occur during the streaming session.

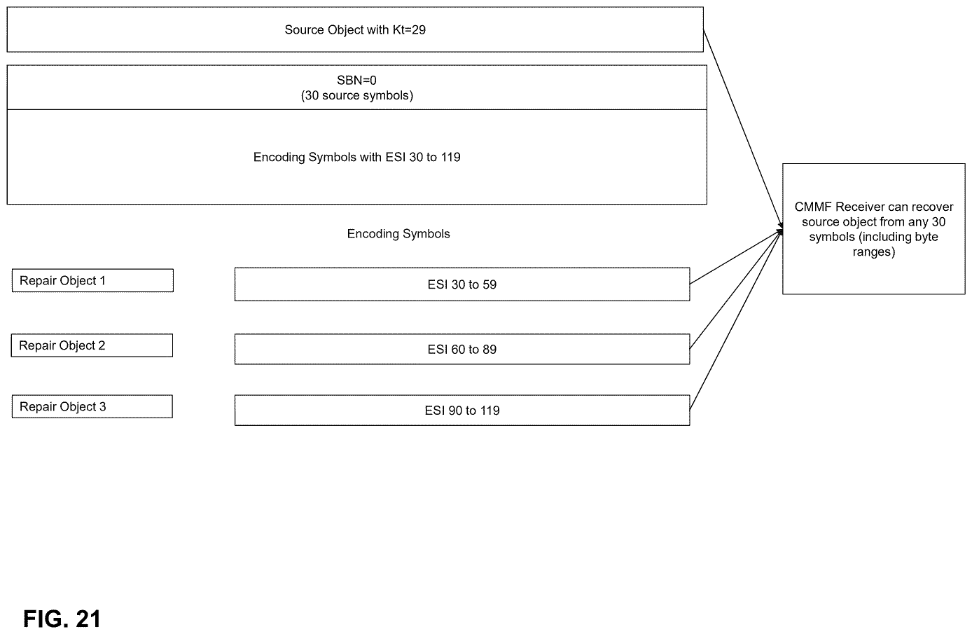

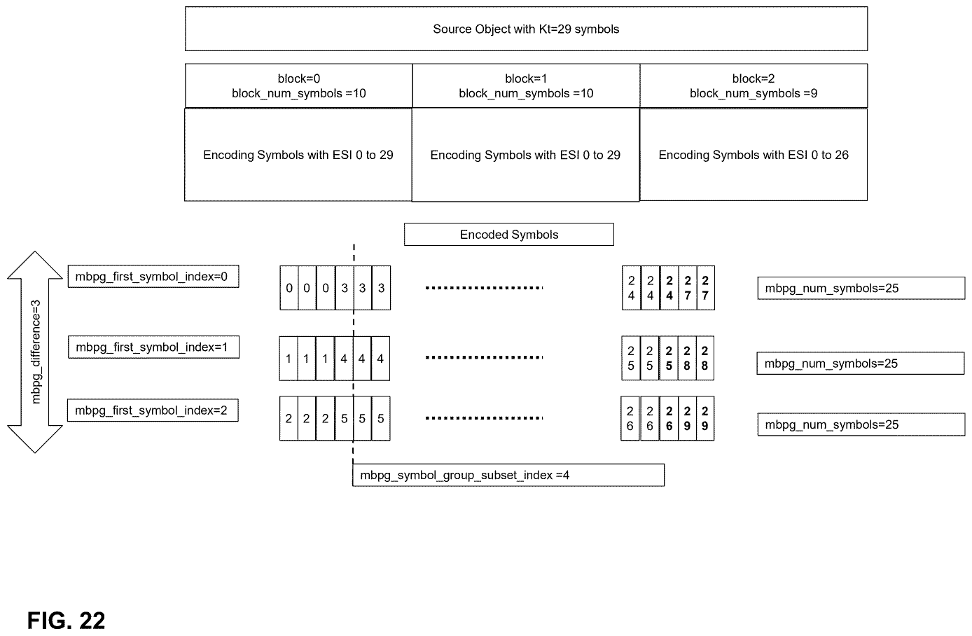

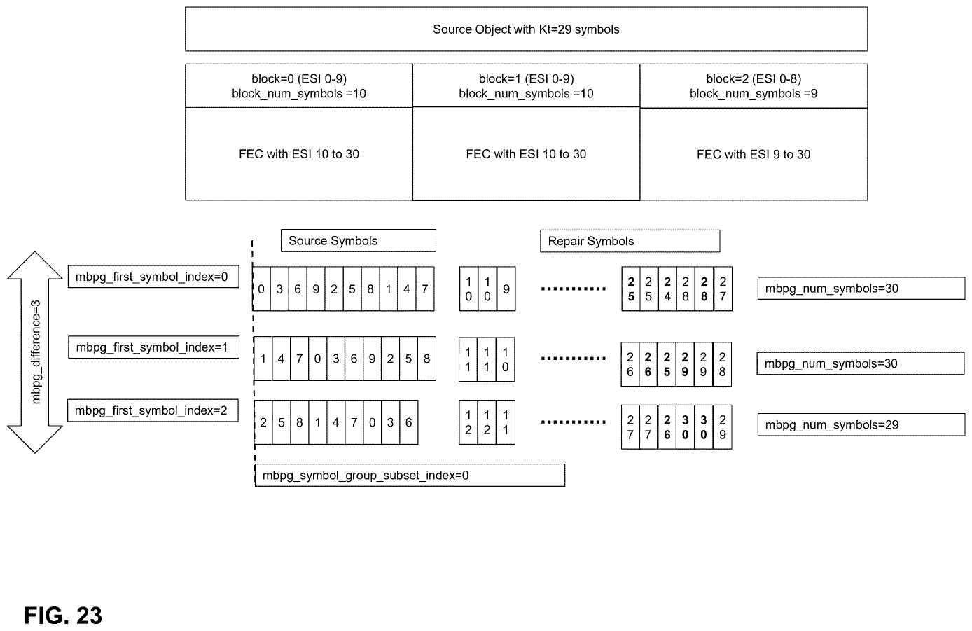

FIGS. 21-23 are conceptual diagrams illustrating example encoding options for CMMF transport objects.

In some implementations, the CMMF Configuration Information may be provided in an Extended File Delivery Table (EFDT), which may be aligned with the File Delivery Table from FLUTE with certain extensions. The following pseudocode represents one example of an EFDT that provides configuration information for a single file with both source and partial encoding objects:

```
<?xml version=“1.0” encoding=“UTF-8”?>
<FDTInstance xmlns:xsi=“http://www.w3.org/2001/XMLSchema-instance”
  xmlns=“urn:ETSI:CMMF:2023:FDT”
  xsi:schemaLocation=“urn:ETSI:CMMF:2023:FDT extendedFDT.xsd”
  Expires=“2024-05-30T09:30:10Z”
  Complete=“true”
  ContentType=“video/mp4 codecs=‘avc1.42c01e,mp4a.40.29’ profiles=‘iso8’”
  FEC-Encoding-ID=“6”
  FEC-Encoding-Symbol-Length=“64”>
  <File ContentLocation=“https://example.com/efd1.mp4”
      TOI=“0”
      Content-Length=“64000”>
    <EncodedObjects type=“source”
independentObject=“true”>https://example.com/efd1.mp4</EncodedObjects>
    <EncodedObjects type=“partial”
      interleavingType=“sequential-sbn”
includedSymbols=“500,0,1001”>https://example.com/part1.cmf</EncodedObjec
ts>
    <EncodedObjects type=“partial”
      interleavingType=“sequential-sbn”
includedSymbols=“500,0,1501”>https://example.com/part2.cmf</EncodedObjec
ts>
    <EncodedObjects type=“partial”
      interleavingType=“sequential-sbn”
includedSymbols=“500,0,2001”>https://example.com/part3.cmf</EncodedObjec
ts>
  </File>
</FDTInstance>
```

The following pseudocode represents an example of configuration information for multiple files that are self-contained objects including source symbols:

```
<FDTInstance xmlns:xsi=“http://www.w3.org/2001/XMLSchema-instance”
  xmlns=“urn:ETSI:CMMF:2023:FDT”
  xsi:schemaLocation=“urn:ETSI:CMMF:2023:FDT extendedFDT.xsd”
  Expires=“2024-05-30T09:30:10Z”
  Complete=“true”
  FEC-OTI-FEC-Encoding-ID=“6”
  FEC-OTI-Encoding-Symbol-Length=“64”>
  <File ContentLocation=“https://example.com/efd1-video.mp4”
      ContentType=“video/mp4 codecs=‘avc1.42c01e’ profiles=‘iso8’”
      TOI=“0”
      Content-Length=“64000”>
    <EncodedObjects type=“self-contained”
      interleavingType=“spread”
      independentObject=“true”
      includedSymbols=“1001,3,1,0,0,0”>https://example.com/part1-
video.cmf</EncodedObjects>
    <EncodedObjects type=“self-contained”
      interleavingType=“spread”
      independentObject=“true”
      includedSymbols=“1001,3,1,0,0,1”>https://example.com/part2-
video.cmf</EncodedObjects>
    <EncodedObjects type=“self-contained”
      interleavingType=“spread”
      independentObject=“true”
      includedSymbols=“1001,3,1,0,0,2”>https://example.com/part3-
video.cmf</EncodedObjects>
  </File>
  <File ContentLocation=“https://example.com/efd1-audio.mp4”
      ContentType=“audio/mp4 codecs=‘mp4a.40.29’ profiles=‘iso8’”
      TOI=“1”
      Content-Length=“4800”>
    <EncodedObjects type=“self-contained”
      interleavingType=“spread”
      independentObject=“true”
      includedSymbols=“80,3,1,0,0,0”>https://example.com/part1-
audio.cmf</EncodedObjects>
    <EncodedObjects type=“self-contained”
      interleavingType=“spread”
      independentObject=“true”
      includedSymbols=“80,3,1,0,0,1”>https://example.com/part2-
audio.cmf</EncodedObjects>
    <EncodedObjects type=“self-contained”
      interleavingType=“spread”
      independentObject=“true”
      includedSymbols=“80,3,1,0,0,2”>https://example.com/part3-
audio.cmf</EncodedObjects>
  </File>
</FDTInstance>
```

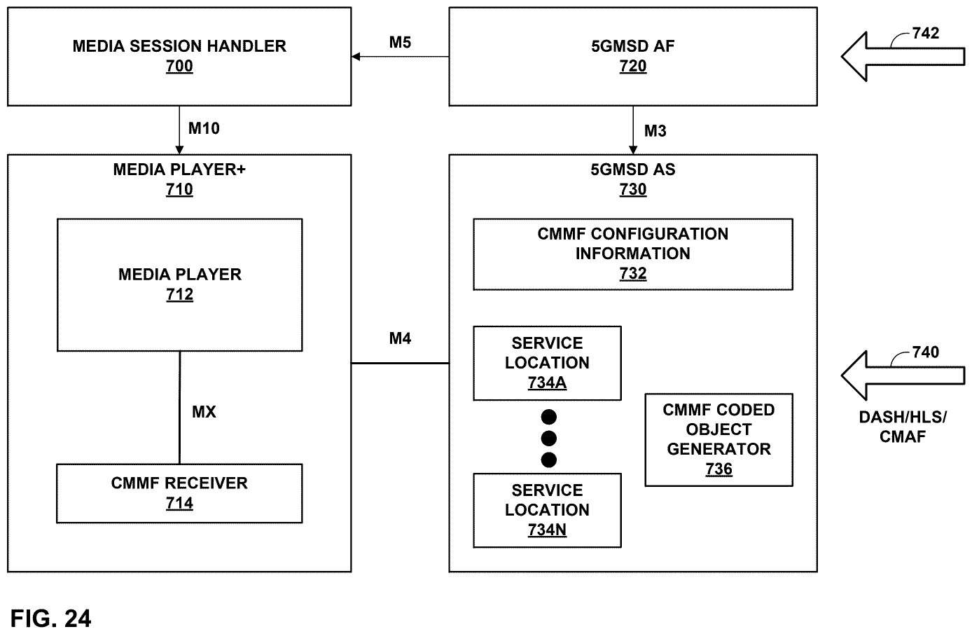

FIG. 24 is a block diagram illustrating a combined CDP-based CMMF and 5G media streaming architecture. In this example, a UE includes MSH 700 and media player⁺ 710. Media player⁺ 710 includes media player 712 and CMMF receiver 714 that interacts with a “5GMS AS”-like server. 5GMSd AF 720 and 5GMSd AS 730 are also depicted, where 5GMSd AS 730 includes CMMF configuration information 732, multiple service locations 734A-734N, and CMMF coded object generator 736.

5GMSd AS 730 receives media data, e.g., DASH/HLS/CMAF media 740, and 5GMSd AF 720 receives provisioning information 742 (e.g., from a 5GMSd AP, not shown in FIG. 24). As discussed above with respect to FIG. 19, 5GMSd AS 730 may send an EFDT advertising network locations (e.g., URLs) of service locations 734A-734N to media player⁺ 710. In this manner, the techniques of this disclosure regarding retrieval of media data from multiple service locations may be used in the context of CMMF and FLUTE.

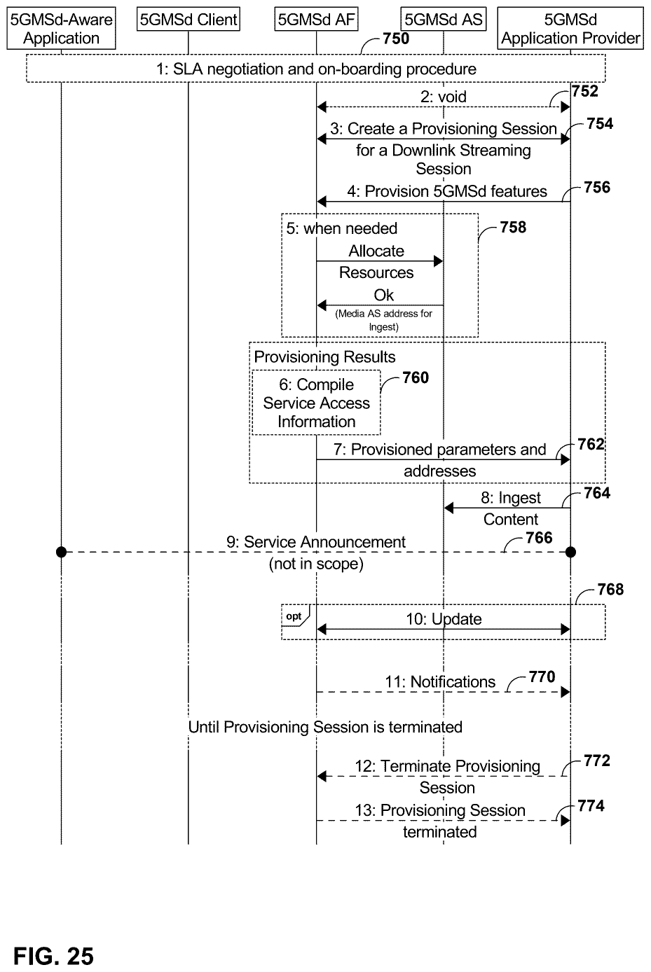

FIG. 25 is a call flow diagram illustrating a provisioning call flow using CMMF. In this example, the method involves the use of specific provisioning parameters exchanged between the 5GMSd Application Provider, the 5GMSd Application Function (AF), and the 5GMSd Application Server (AS) to set up a multi-service location streaming session using CMMF. Provisioning parameters for this method include a request for CMMF processing with configuration parameters, parameters for CMMF processing, and service location parameters. The parameters for CMMF processing include a number of service locations, formation of source and repair objects (e.g., spreading and size), usage of FEC codes with code parameters, and distribution of the media player entry. The service location parameters include the number of service locations and parameters for each service location, such as different QoS parameters, different slices, or the like.

Initially, the 5GMSd Application Provider, 5GMSd AF, and 5GMSd AS engage in a Service Level Agreement (SLA) negotiation and on-boarding procedure (750). Following an initial void message exchange between the 5GMSd Application Provider and the 5GMSd AF (752), the 5GMSd Application Provider initiates the session by sending a request to the 5GMSd AF to create a provisioning session for a downlink streaming session (754).

In response, the 5GMSd AP provisions the 5GMSd AF with 5GMSd features (756). Such provisioning may include configuring the 5GMSd AF for CMMF processing and multi-service location delivery based on the parameters provided by the 5GMSd AP. When needed, the 5GMSd AF and 5GMSd AS perform a resource allocation procedure (758), which may result results in the 5GMSd AS providing the 5GMSd AF with a Media AS address to be used for content ingestion.

The 5GMSd AF may then compile the service access information (760) and may send the provisioned parameters and addresses back to the 5GMSd Application Provider (762). Using this information, the 5GMSd Application Provider ingests the content into the 5GMSd AS (764) at the corresponding AS address (e.g., URL). Subsequently, the 5GMSd AP may send a service announcement to the 5GMSd-Aware Application on a client device (766).

During the provisioning session, the 5GMSd Application Provider may optionally send updates to the 5GMSd AF (768). In turn, the 5GMSd AF may send notifications back to the 5GMSd Application Provider (770) indicating that the updates have been received and performed.

The process may continue until the provisioning session is terminated. To end the provisioning session, the 5GMSd AF may sends a request to the 5GMSd AS to terminate the provisioning session (772), and the 5GMSd AS may confirm that the provisioning session has been terminated (774).

In this manner, the method of FIG. 25 represents an example of a method of retrieving media data, including: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations. The method may further include establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

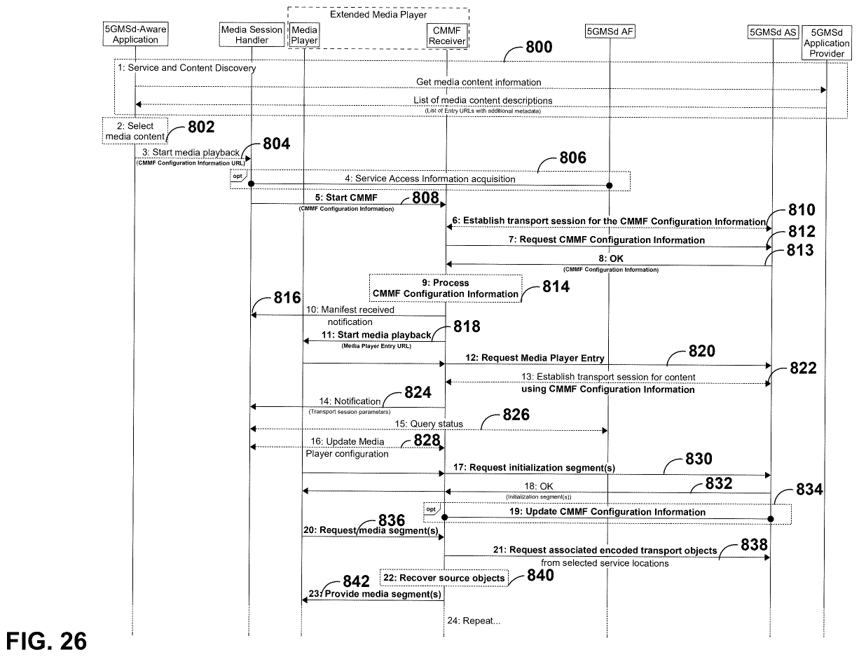

FIG. 26 is a call flow diagram illustrating a method for performing media streaming using CMMF and multiple service locations according to techniques of this disclosure. A service announcement includes a CMMF configuration information URL and MIME type. The media session handler (MSH) starts a CMMF portion of the extended media player. The CMMF receiver collects CMMF configuration information as discussed above. The CMMF receiver identifies the MPD and starts the media player. The media player identifies segments to be requested and requests these from the CMMF receiver. The CMMF receiver, based on continuous updates, collects the associated encoded objects, recovers the source objects, and provides the media segments to the media player. In some examples, certain parts of the information may be sent directly to the media player. Configuration information for CMMF may be static or dynamic.

Initially, a 5GMS-aware application performs service and content discovery (800) with a 5GMSd Application Provider. After the 5GMS-aware application selects the desired media content (802), the 5GMS-aware application starts media playback (804) by providing a CMMF Configuration Information URL to the MSH. The MSH may optionally perform service access information acquisition with the 5GMSd AF (806). The MSH then instructs the CMMF receiver to start by passing it the CMMF Configuration Information (808).

The CMMF receiver may then establish a transport session with the 5GMSd AS (810) and request CMMF configuration information from the 5GMSd AS (812). In response, the 5GMSd AS provides the CMMF configuration information (813) to the CMMF receiver, which the CMMF receiver processes (814).

Afterwards, the CMMF receiver sends a manifest received notification to the MSH including the manifest (816). Thus, the media player may start media playback (818) using the Media Player Entry URL. The media player then requests the Media Player Entry from the CMMF receiver via the CMMF receiver (820).

The CMMF receiver establishes a transport session for the content with the 5GMSd AS using the configuration information (822). The CMMF receiver notifies the MSH of transport session parameters for the transport session (824). The MSH and the 5GMSd AF execute a status query (826) and updates the media player configuration (828).

The media player then requests initialization segment(s) from the 5GMSd AS via the CMMF receiver (830). The CMMF receiver recovers and provides the initialization segments (832) to the media player. During the session, the 5GMSd AS may send updated CMMF configuration information to the CMMF receiver (834).

The media player may then request media segments (836) from the CMMF receiver. In response, the CMMF receiver requests the associated encoded transport objects from the selected service locations (e.g., the 5GMSd AS) (838), recovers the source objects (840), and provides the reconstructed media segments to the media player (842). This process may repeat for the duration of the media session.

In this manner, the method of FIG. 26 represents an example of a method of retrieving media data, including: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations. The method may further include establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

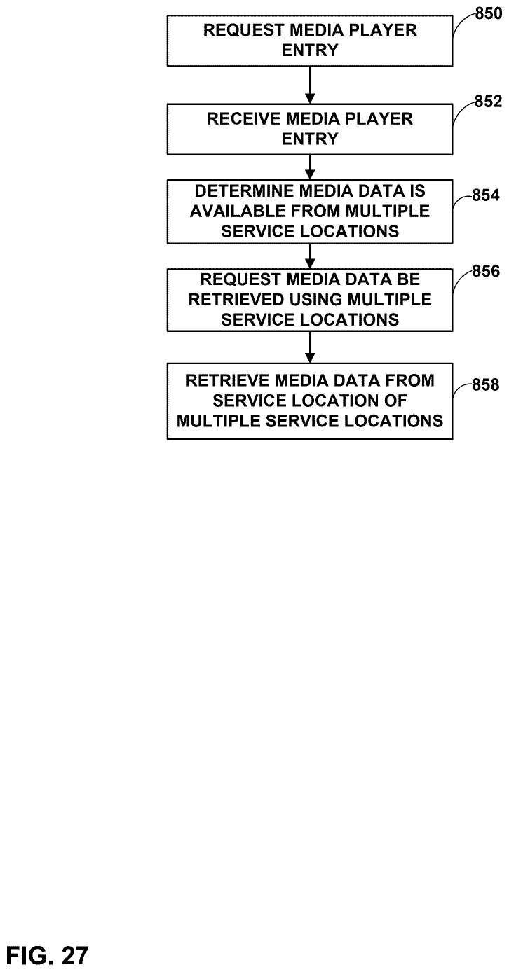

FIG. 27 is a flowchart illustrating an example method of retrieving media data available from multiple service locations per techniques of this disclosure. The method of FIG. 27 may be performed by, e.g., client device 40 of FIG. 1, UE 220 of FIG. 5, or UE 220′ of FIG. 6, any which may include components similar to media player⁺ 240 of FIG. 7, media session handler 272 and media player⁺ 240 of FIG. 8, 5GMS-aware application 300 and media player⁺ 310 of FIGS. 9 and 10, MSH 304 of FIG. 10, and/or CMMF receiver 620 and CMMF-aware application/CMMF client 630 of FIG. 18.

Initially, a client device (such as a UE) may request a media player entry from a server device (e.g., a 5GMSd AS) for a media presentation (850). In response, the client device may receive the media player entry (852). The media player entry may be a manifest file, such as a media presentation description (MPD) of DASH or a playlist file for HLS. The client device may determine that the media player entry indicates that media data of the media presentation is available from multiple service locations (854). Thus, the client device may request that media data of the media presentation be retrieved using the multiple service locations (856). For example, the client device may request steering from a steering server to select a service location from which to retrieve media data, request different types of media data (e.g., audio, video, timed text, or the like) from different service locations, or otherwise request a first portion of the media data from a first service location via a first transport session and a second portion of the media data from a second service location via a second service transport session. Thus, the client device may retrieve media data of the media presentation from one or more service locations of the multiple available service locations (858).

In this manner, the method of FIG. 27 represents an example of a method of retrieving media data, including: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations. The method may further include establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

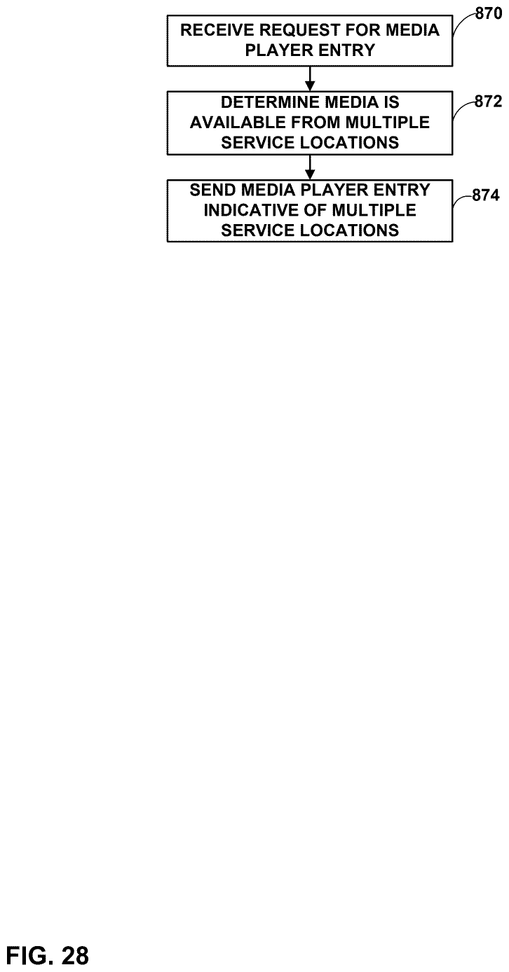

FIG. 28 is a flowchart illustrating an example method of exchanging media data by a server device per techniques of this disclosure. The server device may be, for example, a 5GMSd AS, a 5GMSd AP, a 5GMSd AF, or the like as discussed in this disclosure.

Initially, the server device may receive a request for a media player entry for a media presentation from a client device (870). The server device may determine that media data for a media presentation corresponding to the requested media player entry is available from multiple service locations (872). Thus, the server device may send the media player entry, including data indicating that the corresponding media data is available from multiple service locations (874). For example, the server device may select an existing media player entry indicating the multiple service locations. Alternatively, the server device may update an existing media player entry to include data representative of the multiple service locations. The data representative of the multiple service locations may include, for example, base URLs for the media data of the media presentation for each of the service locations.

In this manner, the method of FIG. 28 represents an example of a method of exchanging media data, including: receiving, by a server device, a request for a media player entry for a media presentation from a client device; determining, by the server device, that media data of the media presentation is available from multiple service locations; and sending, by the server device, the media player entry for the media presentation to the client device, the media player entry indicating that the media data of the media presentation is available from the multiple service locations.

Various examples of the techniques of this disclosure are summarized in the following clauses:

Clause 1: A method of retrieving media data, the method comprising: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations.

Clause 2: The method of clause 1, wherein determining that the media data of the media presentation is available from the multiple service locations comprises retrieving a media player entry including data representing the multiple service locations.

Clause 3: The method of clause 2, wherein the media player entry comprises a manifest file.

Clause 4: The method of clause 3, wherein the manifest file comprises a media presentation description (MPD).

Clause 5: The method of any of clauses 2-4, wherein determining comprises executing, by the client device, a media player application, the method further comprising executing, by the client device, the media player application to cause the media player application to send a notification to a media session handler (MSH) of the client device indicating that the media player entry has been retrieved.

Clause 6: The method of any of clauses 1-5, further comprising retrieving service location information from a 5G media streaming client for downlink (5GMSd) application server (AS).

Clause 7: The method of clause 6, further comprising establishing one or more transport sessions using the service location information, wherein retrieving the media data comprises retrieving the media data via the one or more transport sessions.

Clause 8: The method of any of clauses 6 and 7, further comprising receiving an update to the service location information.

Clause 9: The method of clause 8, wherein receiving the update to the service location information comprises receiving a media segment including a portion of the media data and the update to the service location information.

Clause 10: The method of clause 8, wherein receiving the update to the service location information comprises receiving an update to a media player entry including the update to the service location information.

Clause 11: The method of any of clauses 8-10, further comprising retrieving subsequent media data of the media presentation according to the update to the service location information.

Clause 12: The method of any of clauses 1-11, wherein generating the request for the media data comprises generating the request to include content steering parameters.

Clause 13: The method of any of clauses 1-12, further comprising: establishing a first transport session for common multisource media format (CMMF) configuration information; receiving the CMMF configuration information via the first transport session; and establishing a second transport session for the media data using the CMMF configuration information, wherein retrieving the media data comprises retrieving the media data via the second transport session.

Clause 14: A method of exchanging media data, the method comprising: receiving, by a server device, a request for media data of a media presentation from a client device, the request including data indicating that the media data is to be retrieved using multiple service locations; retrieving, by the server device, the media data using the multiple service locations; and sending, by the server device, the media data to the client device.

Clause 15: The method of clause 14, further comprising sending a media player entry indicating that the media data is available from the multiple service locations to the client device.

Clause 16: The method of clause 15, wherein the media player entry comprises a manifest file.

Clause 17: The method of clause 16, wherein the manifest file comprises a media presentation description (MPD).

Clause 18: The method of any of clauses 14-17, wherein the server device comprises a 5G media streaming client for downlink (5GMSd) application server (AS), the method further comprising sending service location information to the client device.

Clause 19: The method of clause 18, further comprising establishing one or more transport sessions using the service location information, wherein sending the media data comprises sending the media data via the one or more transport sessions.

Clause 20: The method of any of clauses 18 and 19, further comprising sending an update to the service location information to the client device.

Clause 21: The method of clause 20, wherein sending the update to the service location information comprises sending an update to a media player entry including the update to the service location information.

Clause 22: The method of any of clauses 14-21, further comprising extracting content steering parameters from the request for the media data.

Clause 23: The method of any of clauses 14-22, further comprising: establishing a first transport session for common multisource media format (CMMF) configuration information with the client device; sending the CMMF configuration information via the first transport session; and establishing a second transport session for the media data using the CMMF configuration information, wherein sending the media data comprises sending the media data via the second transport session.

Clause 24: A method of exchanging media data, the method comprising: receiving, by an edge server device, a request for media data from a client device; determining, by the edge server device, that the media data of the request is available from multiple content delivery network (CDN) providers; determining, by the edge server device, at least one of the CDN providers from which to retrieve the media data of the request; retrieving, by the edge server device, the media data of the request from the at least one of the CDN providers; and sending, by the edge server device, the media data to the client device.

Clause 25: The method of clause 24, wherein determining the at least one of the CDN providers comprises: performing a multi-CDN domain name system (DNS) lookup using a domain for the media data; and receiving a list of Internet protocol (IP) addresses for the CDN providers including two or more IP addresses.

Clause 26: The method of clause 25, further comprising selecting one or more of the CDN providers from which to retrieve the media data based on one or more of: performance, latency, bandwidth, cost, and geographic location of the client device.

Clause 27: A device for retrieving media data, the device comprising one or more means for performing the method of any of clauses 1-26

Clause 28: The device of clause 27, wherein the one or more means comprise a processing system implemented in circuitry.

Clause 29: The device of clause 27, wherein the device comprises at least one of: an integrated circuit; a microprocessor; and a wireless communication device.

Clause 30: A client device for retrieving media data, the client device comprising: means for determining that media data of a media presentation is available from multiple service locations; means for generating a request for the media data of the media presentation, including specifying in the request that the media data is to be retrieved using the multiple service locations; and means for retrieving the media data from at least one of the multiple service locations.

Clause 31: A server device for exchanging media data, the server device comprising: means for receiving a request for media data of a media presentation from a client device, the request including data indicating that the media data is to be retrieved using multiple service locations; means for retrieving the media data using the multiple service locations; and means for sending the media data to the client device.

Clause 32: An edge server device for exchanging media data, the edge server device comprising: means for receiving a request for media data from a client device; means for determining that the media data of the request is available from multiple content delivery network (CDN) providers; means for determining at least one of the CDN providers from which to retrieve the media data of the request; means for retrieving the media data of the request from the at least one of the CDN providers; and means for sending the media data to the client device.

Clause 33: A method of retrieving media data, the method comprising: determining, by a client device, that media data of a media presentation is available from multiple service locations; generating, by the client device, a request for the media data of the media presentation, including specifying in the request that the media data is to be retrieved using the multiple service locations; and retrieving, by the client device, the media data from at least one of the multiple service locations.

Clause 34: The method of clause 33, further comprising: establishing a first transport session with a first service location of the multiple service locations; and establishing a second transport session with a second service location of the multiple service locations, the second service location being different than the first service location, wherein retrieving the media data comprises: retrieving a first portion of the media data from the first service location via the first transport session; and retrieving a second portion of the media data from the second service location via the second transport session.

Clause 35: The method of clause 33, wherein determining that the media data of the media presentation is available from the multiple service locations comprises retrieving a media player entry including data representing the multiple service locations.

Clause 36: The method of clause 35, wherein the media player entry comprises a manifest file.

Clause 37: The method of clause 36, wherein the manifest file comprises a media presentation description (MPD).

Clause 38: The method of clause 35, wherein determining comprises executing, by the client device, a media player application, the method further comprising executing, by the client device, the media player application to cause the media player application to send a notification to a media session handler (MSH) of the client device indicating that the media player entry has been retrieved.

Clause 39: The method of clause 33, further comprising retrieving service location information from a 5G media streaming client for downlink (5GMSd) application server (AS).

Clause 40: The method of clause 39, further comprising establishing one or more transport sessions using the service location information, wherein retrieving the media data comprises retrieving the media data via the one or more transport sessions.

Clause 41: The method of clause 39, further comprising receiving an update to the service location information.

Clause 42: The method of clause 41, wherein receiving the update to the service location information comprises receiving a media segment including a portion of the media data and the update to the service location information.

Clause 43: The method of clause 41, wherein receiving the update to the service location information comprises receiving an update to a media player entry including the update to the service location information.

Clause 44: The method of clause 41, further comprising retrieving subsequent media data of the media presentation according to the update to the service location information.

Clause 45: The method of clause 33, wherein generating the request for the media data comprises generating the request to include content steering parameters.

Clause 46: The method of clause 33, further comprising: establishing a first transport session for common multisource media format (CMMF) configuration information; receiving the CMMF configuration information via the first transport session; and establishing a second transport session for the media data using the CMMF configuration information, wherein retrieving the media data comprises retrieving the media data via the second transport session.

Clause 47: A device for retrieving media data, the device comprising: a memory configured to store media data; and a processing system implemented in circuitry and configured to: determine that media data of a media presentation is available from multiple service locations; generate a request for the media data of the media presentation such that the request specifies that the media data is to be retrieved using the multiple service locations; and retrieve the media data from at least one of the multiple service locations.

Clause 48: The device of clause 47, wherein the processing system is further configured to: establish a first transport session with a first service location of the multiple service locations; and establish a second transport session with a second service location of the multiple service locations, the second service location being different than the first service location, wherein to retrieve the media data, the processing system is configured to: retrieve a first portion of the media data from the first service location via the first transport session; and retrieve a second portion of the media data from the second service location via the second transport session.

Clause 49: The device of clause 47, wherein to determine that the media data of the media presentation is available from the multiple service locations, the processing system is configured to retrieve a media player entry including data representing the multiple service locations.

Clause 50: The device of clause 49, wherein the processing system is further configured to execute a media session handler and to execute a media player application to send a notification to the MSH indicating that the media player entry has been retrieved.

Clause 51: The device of clause 47, wherein the processing system is further configured to retrieve service location information from a 5G media streaming client for downlink (5GMSd) application server (AS), the 5GMSd AS comprising one of the multiple service locations.

Clause 52: The device of clause 47, wherein the processing system is further configured to generate the request to include content steering parameters.

Clause 53: A method of exchanging media data, the method comprising: receiving, by a server device, a request for a media player entry for a media presentation from a client device; determining, by the server device, that media data of the media presentation is available from multiple service locations; and sending, by the server device, the media player entry for the media presentation to the client device, the media player entry indicating that the media data of the media presentation is available from the multiple service locations.

Clause 54: The method of clause 53, wherein the media player entry comprises a manifest file.

Clause 55: The method of clause 54, wherein the manifest file comprises a media presentation description (MPD).

Clause 56: The method of clause 53, wherein the media player entry includes base uniform resource locators (BaseURLs) for each of the multiple service locations, each of the multiple service locations corresponding to a different respective 5GMSd Application Server (AS).

Clause 57: The method of clause 53, further comprising updating, by the server device, the media player entry to include data indicating that the media data of the media presentation is available from the multiple service locations prior to sending the media player entry to the client device.

Clause 58: A server device for exchanging media data, the server device comprising: a memory configured to store a media player entry for a media presentation; and a processing system implemented in circuitry and configured to: receive a request for the media player entry from a client device; determine that media data of the media presentation is available from multiple service locations; and send the media player entry for the media presentation to the client device, the media player entry indicating that the media data of the media presentation is available from the multiple service locations.

Clause 59: The device of clause 58, wherein the media player entry comprises a manifest file.

Clause 60: The device of clause 59, wherein the manifest file comprises a media presentation description (MPD).

Clause 61: The device of clause 58, wherein the media player entry includes base uniform resource locators (BaseURLs) for each of the multiple service locations, each of the multiple service locations corresponding to a different respective 5GMSd Application Server (AS).

Clause 62: The method of clause 53, wherein the processing system is further configured to update the media player entry to include data indicating that the media data of the media presentation is available from the multiple service locations prior to sending the media player entry to the client device.

Clause 63: A method of exchanging media data, the method comprising: receiving, by a server device, a request for media data of a media presentation from a client device, the request including data indicating that the media data is to be retrieved using multiple service locations; retrieving, by the server device, the media data using the multiple service locations; and sending, by the server device, the media data to the client device.

Clause 64: The method of clause 63, further comprising sending a media player entry indicating that the media data is available from the multiple service locations to the client device.

Clause 65: The method of clause 64, wherein the media player entry comprises a manifest file.

Clause 66: The method of clause 65, wherein the manifest file comprises a media presentation description (MPD).

Clause 67: The method of any of clauses 63-66, wherein the server device comprises a 5G media streaming client for downlink (5GMSd) application server (AS), the method further comprising sending service location information to the client device.

Clause 68: The method of clause 67, further comprising establishing one or more transport sessions using the service location information, wherein sending the media data comprises sending the media data via the one or more transport sessions.

Clause 69: The method of any of clauses 67 and 68, further comprising sending an update to the service location information to the client device.

Clause 70: The method of clause 69, wherein sending the update to the service location information comprises sending an update to a media player entry including the update to the service location information.

Clause 71: The method of any of clauses 63-70, further comprising extracting content steering parameters from the request for the media data.

Clause 72: The method of any of clauses 63-71, further comprising: establishing a first transport session for common multisource media format (CMMF) configuration information with the client device; sending the CMMF configuration information via the first transport session; and establishing a second transport session for the media data using the CMMF configuration information, wherein sending the media data comprises sending the media data via the second transport session.

Clause 73: A method of exchanging media data, the method comprising: receiving, by an edge server device, a request for media data from a client device; determining, by the edge server device, that the media data of the request is available from multiple content delivery network (CDN) providers; determining, by the edge server device, at least one of the CDN providers from which to retrieve the media data of the request; retrieving, by the edge server device, the media data of the request from the at least one of the CDN providers; and sending, by the edge server device, the media data to the client device.

Clause 74: The method of clause 73, wherein determining the at least one of the CDN providers comprises: performing a multi-CDN domain name system (DNS) lookup using a domain for the media data; and receiving a list of Internet protocol (IP) addresses for the CDN providers including two or more IP addresses.

Clause 75: The method of clause 74, further comprising selecting one or more of the CDN providers from which to retrieve the media data based on one or more of: performance, latency, bandwidth, cost, and geographic location of the client device.

Clause 76: A device for retrieving media data, the device comprising one or more means for performing the method of any of clauses 1-75.

Clause 77: The device of clause 76, wherein the one or more means comprise a processing system implemented in circuitry.

Clause 78: The device of clause 76, wherein the device comprises at least one of: an integrated circuit; a microprocessor; and a wireless communication device.

Clause 79: A client device for retrieving media data, the client device comprising: means for determining that media data of a media presentation is available from multiple service locations; means for generating a request for the media data of the media presentation, including specifying in the request that the media data is to be retrieved using the multiple service locations; and means for retrieving the media data from at least one of the multiple service locations.

Clause 80: A server device for exchanging media data, the server device comprising: means for receiving a request for a media player entry for a media presentation from a client device; means for determining that media data of the media presentation is available from multiple service locations; and means for sending the media player entry for the media presentation to the client device, the media player entry indicating that the media data of the media presentation is available from the multiple service locations.

Clause 81: A server device for exchanging media data, the server device comprising: means for receiving a request for media data of a media presentation from a client device, the request including data indicating that the media data is to be retrieved using multiple service locations; means for retrieving the media data using the multiple service locations; and means for sending the media data to the client device.

Clause 82: An edge server device for exchanging media data, the edge server device comprising: means for receiving a request for media data from a client device; means for determining that the media data of the request is available from multiple content delivery network (CDN) providers; means for determining at least one of the CDN providers from which to retrieve the media data of the request; means for retrieving the media data of the request from the at least one of the CDN providers; and means for sending the media data to the client device.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving media data, the method comprising:
determining, by a client device, that media data of a media presentation is available from multiple service locations;
sending, by the client device, a request for the media data of the media presentation, including specifying in the request that the media data is to be retrieved using the multiple service locations; and
retrieving, by the client device, the media data from at least one of the multiple service locations.

2. The method of claim 1, further comprising:
establishing a first transport session with a first service location of the multiple service locations; and
establishing a second transport session with a second service location of the multiple service locations, the second service location being different than the first service location,
wherein retrieving the media data comprises:
retrieving a first portion of the media data from the first service location via the first transport session; and
retrieving a second portion of the media data from the second service location via the second transport session.

3. The method of claim 1, wherein determining that the media data of the media presentation is available from the multiple service locations comprises retrieving a media player entry including data representing the multiple service locations.

4. The method of claim 3, wherein the media player entry comprises a manifest file.

5. The method of claim 4, wherein the manifest file comprises a media presentation description (MPD).

6. The method of claim 3, wherein determining comprises executing, by the client device, a media player application, the method further comprising executing, by the client device, the media player application to cause the media player application to send a notification to a media session handler (MSH) of the client device indicating that the media player entry has been retrieved.

7. The method of claim 1, further comprising retrieving service location information from a 5G media streaming client for downlink (5GMSd) application server (AS).

8. The method of claim 7, further comprising establishing one or more transport sessions using the service location information, wherein retrieving the media data comprises retrieving the media data via the one or more transport sessions.

9. The method of claim 7, further comprising receiving an update to the service location information.

10. The method of claim 9, wherein receiving the update to the service location information comprises receiving a media segment including a portion of the media data and the update to the service location information.

11. The method of claim 9, wherein receiving the update to the service location information comprises receiving an update to a media player entry including the update to the service location information.

12. The method of claim 9, further comprising retrieving subsequent media data of the media presentation according to the update to the service location information.

13. The method of claim 1, wherein generating the request for the media data comprises generating the request to include content steering parameters.

14. The method of claim 1, further comprising:
establishing a first transport session for common multisource media format (CMMF) configuration information;
receiving the CMMF configuration information via the first transport session; and
establishing a second transport session for the media data using the CMMF configuration information,
wherein retrieving the media data comprises retrieving the media data via the second transport session.

15. A device for retrieving media data, the device comprising:
a memory configured to store media data; and
a processing system implemented in circuitry and configured to:
determine that media data of a media presentation is available from multiple service locations;
send a request for the media data of the media presentation, wherein the request specifies that the media data is to be retrieved using the multiple service locations; and
retrieve the media data from at least one of the multiple service locations.

16. The device of claim 15, wherein the processing system is further configured to:
establish a first transport session with a first service location of the multiple service locations; and
establish a second transport session with a second service location of the multiple service locations, the second service location being different than the first service location,
wherein to retrieve the media data, the processing system is configured to:
retrieve a first portion of the media data from the first service location via the first transport session; and
retrieve a second portion of the media data from the second service location via the second transport session.

17. The device of claim 15, wherein to determine that the media data of the media presentation is available from the multiple service locations, the processing system is configured to retrieve a media player entry including data representing the multiple service locations.

18. The device of claim 17, wherein the processing system is further configured to execute a media session handler and to execute a media player application to send a notification to the MSH indicating that the media player entry has been retrieved.

19. The device of claim 15, wherein the processing system is further configured to retrieve service location information from a 5G media streaming client for downlink (5GMSd) application server (AS), the 5GMSd AS comprising one of the multiple service locations.

20. The device of claim 15, wherein the processing system is further configured to generate the request to include content steering parameters.
